(19) United States
(12) Patent Application Publication
(10) Pub. No.: US 2020/0065802 A1
(43) Pub. Date: Feb. 27, 2020

(54) ELIGIBILITY OF A DIGITAL ASSET FOR A TRANSACTION

(71) Applicant: Digital Asset (Switzerland) GmbH, Zurich (CH)

(72) Inventors: Kelly MATHIESON, New York, NY (US); Talia Faye KLEIN, New York, NY (US); Levente BARCZY, New York, NY (US); Silvan VILLIGER, Zurich (CH); Charles-Edmond RENOUARD, Zurich (CH); Beth SENDRA, New York, NY (US); Avinash BURRA, New York, NY (US); Charng-Ching YEH, New York, NY (US)

(73) Assignee: Digital Asset (Switzerland) GmbH, Zurich (CH)

(21) Appl. No.: 16/523,035

(22) Filed: Jul. 26, 2019

Related U.S. Application Data
(60) Provisional application No. 62/723,043, filed on Aug. 27, 2018.

(51) Int. Cl. G06Q 20/38; G06Q 20/40; G06Q 20/36; H04L 9/06

(52) U.S. Cl. CPC G06Q 20/3825; H04L 9/0637; G06Q 20/3674; G06Q 20/401

(57) ABSTRACT

The present disclosure relates to a system for determining the eligibility of a digital asset associated with a unique identifier for a transaction. The system may include a first computer node including a first processing device and memory, the computer node including program instructions that, when executed: send a proposed automated tagging request associated with the digital asset, the proposed automated tagging request including an algorithm configured to determine one or more eligibility tags based on input data from one or more input data sources; receive, from a second node, an acceptance notification indicating acceptance of the proposed automated tagging request; and validate that program instructions including the algorithm are recorded to a distributed ledger associated with the digital asset.

### CROSS-REFERENCE TO RELATED APPLICATION

The present application claims priority from U.S. Provisional Patent Application No 62/723,043, filed on Aug. 27, 2018, which is incorporated herein by reference in its entirety.

### TECHNICAL FIELD

The present disclosure is directed towards a system and computer-implemented method for tagging a digital asset in a distributed computer network.

### BACKGROUND

Currently, the process by which users systemically share data regarding classification or attributes of digital assets over a computer network is siloed. The process and taxonomy by which individual participants or entities in a network may classify specific data in varied ways leads to an inability to efficiently communicate between participants. Moreover, the lack of a standardized classification system within any given market (for example, without limitation, financial markets, supply chain management, healthcare services, and identity management) frequently leads to misclassification of digital assets and, in turn, misallocation of desired digital assets. The misallocation of digital assets in markets can cause individual participants or entities to be inappropriately exposed to their counterparties and under collateralized in the event of a default or macroeconomic event.

Given the motivation for users to classify and/or apply specific proprietary attributes to digital assets, the expectation that a given market would standardize its classification and attribute system for use across a given market is unrealistic. Particularly for markets that operate globally, this type of taxonomy standardization would be inherently difficult due to the number of participants and their diverse intentions for these classifications.

Thus, technical problems exist in terms of managing disparate information sources, classifying information, and tagging related attributes to corresponding digital assets. Further, the fact that attributes related to digital assets are maintained in siloes can make it practically difficult to determine the eligibility of a digital asset for a transaction. This can make the exchange of digital assets between different nodes difficult to facilitate. In that respect, it is desirable to achieve tagging of a digital asset in a consistent, repeatable, and reconciled manner across nodes, whilst maintaining privacy of information between at least some of the information sources and nodes.

### SUMMARY

The present disclosure seeks to resolve the above issues by allowing participants in a network to maintain their own proprietary taxonomy for classifying and/or ascribing attributes to certain digital assets (e.g., digital financial instruments), while at the same time reconciling or providing parity (e.g., consensus) between classifications and/or attributes of digital assets as maintained by disparate taxonomies.

Embodiments of the present disclosure include a computer-implemented system and method that may be used for tagging digital assets with industry nomenclature, participant-specific nomenclature, and any other form of nomenclature that may qualify a digital asset for allocation. In an example, the industry and/or participant-specific nomenclature can be data that is representative of certain qualities or characteristics of the digital asset, which may be industry-wide data, proprietary data maintained by a particular participant in a network, or data derived from the foregoing. The digital asset tagging system may be used to manage collateral eligibility (e.g., in the case of financial markets), but it can also be used for identity management or other use cases. Collateral eligibility and management is discussed as a primary use case, but it is to be appreciated the present disclosure may have broader application.

Throughout this specification the word “comprise”, or variations such as “comprises” or “comprising”, shall be understood to imply the inclusion of a stated element, integer or step, or group of elements, integers or steps, but not the exclusion of any other element, integer or step, or group of elements, integers or steps.

Any discussion of documents, acts, materials, devices, articles or the like, which has been included in the present specification is not to be taken as an admission that any or all of these matters form part of the prior art base or were common general knowledge in the field relevant to the present disclosure as it existed before the priority date of each of the appended claims.

There is provided a system for determining the eligibility of a digital asset associated with a unique identifier for a transaction, wherein the system comprises: a first computer node including a first processing device and memory, the computer node including program instructions that, when executed: send a proposed automated tagging request associated with the digital asset, wherein the proposed automated tagging request comprises an algorithm configured to determine one or more eligibility tags based on input data from one or more input data sources; receive, from a second node, an acceptance notification indicating acceptance of the proposed automated tagging request; and validate that program instructions including the algorithm are recorded to a distributed ledger associated with the digital asset.

The digital asset tagging system described above can be facilitated by a smart contract or series of smart contracts running on distributed-ledger technology (“DLT”). The DLT used can be the Digital Asset Platform (e.g., utilizing a Global Synchronization Log (GSL) and Private Contract Store (PCS) architecture), it can be a blockchain, or another DLT system. The potential architectures under which the digital asset tagging system of the present disclosure can run are detailed more fully below.

The system can enable participants to qualify digital assets based on program instructions (e.g., in DAML discussed in detail below) that apply unilaterally, bilaterally or multilaterally, while maintaining the privacy of the program instructions. Such qualified digital assets can then, in an example, be allocated to facilitate transactions or obligations between participants (e.g., in a collateral management system).

In the system, the first node may be configured to cryptographically sign the proposed automated tagging request with a first digital signature associated with the first node.

In another example of the system, the first node may be further configured to cryptographically validate that the acceptance notification from the second node includes a second digital signature associated with the second node, wherein validity of the program instructions is conditional on a valid second digital signature.

In the system, the first node may be associated with a first private data store that stores one or more of the proposed automated tagging request, the acceptance notification and the program instructions.

In the system, the distributed ledger may include a record of one or more of: the proposed automated tagging request; the acceptance notification; the program instructions; and the one or more eligibility tags associated with the unique identifier.

In the system, the first node may be further configured to send a first encrypted private message including the program instructions to a third node.

The system may further comprise a third node comprising a third processing device and memory configured to: receive input data recorded on the distributed ledger from at least a first input data source; execute program instructions, including the algorithm that, based on the input data, associate one or more eligibility tags with the unique identifier of the digital asset, the one or more eligibility tags indicating the eligibility of the digital asset for the transaction; record a representation of the one or more eligibility tags associated with the unique identifier of the digital asset to the distributed ledger; communicate, by means of a private secure channel to a first node and/or second node, an eligibility tag notification providing data representative of the one or more eligibility tags.

In some examples of the system, to communicate the eligibility tag notification, the third node is further configured to send a second encrypted private message including the eligibility tag notification to the first node and/or second node.

In some examples of the system, the third node is further configured to record a cryptographic representation of the one or more eligibility tags to the distributed ledger. In a further example, the cryptographic representation of the one or more eligibility tags comprises a hash of the one or more eligibility tags recorded on the distributed ledger, and/or the one or more eligibility tags recorded on the distributed ledger in encrypted form.

In some examples of the system, the third node is further configured to validate one or more digital signatures associated with the program instructions, wherein validity of the program instructions is conditional on the validity of the one or more digital signature.

In some examples, the system further comprises additional input data sources including: a public data source to provide public input data; and a proprietary data source to provide proprietary input data, wherein the third node is further configured to validate accuracy of the public input data and/or the proprietary input data with further data of a further input data source. In a further example, to validate the accuracy of public input data and/or proprietary input data includes a comparison of respective cryptographic hashes of the data.

In one example, the third node is further configured to store the program instructions in a third private data store associated with the third node.

In the system, the third node may be further configured to: receive, from the first node, a request for a transaction involving the digital asset; determine the unique identifier (8) associated with the digital asset; determine, if any, one or more eligibility tags associated with the unique identifier; and determine authorisation for the transaction based on the one or more eligibility tags, wherein based on successful authorisation, the third node is configured to record the transaction in the distributed ledger.

In some examples of the system, the request further comprises a cryptographic authorisation to transfer control of the digital asset from the first node to the second node based on occurrence of a specified transaction condition, wherein the third node is further configured to monitor input data from the first input data source, and wherein based on identification of an occurrence of the specified transaction condition, control of the digital asset is transferred to the second node.

In some examples of the system, the unique identifier is also associated with a control tag indicating a node having control of the digital asset.

There is also provided a computer-implemented method for determining the eligibility, for a transaction, of a digital asset associated with a unique identifier, the method comprising, by way of a first node including a first processing device and memory: (a) cryptographically signing, with a first digital signature associated with the first node, a proposed automated tagging request related to the digital asset, wherein the proposed automated tagging request comprises an algorithm configured to determine at least one eligibility tag based on input data from at least a first input data source; (b) sending the proposed automated tagging request to a second node; (c) validating that program instructions including the algorithm are recorded to a distributed ledger associated with the digital asset; and (d) validating that the program instructions including the algorithm have, based on the input data, executed and associated one or more eligibility tags to the unique identifier associated with the digital asset. By way of the first node or a third node having a third processing device, and memory, the method further comprises (e) cryptographically signing a transaction involving the digital asset that is recorded to the distributed ledger only if the one or more eligibility tags satisfy predefined criteria.

The computer-implemented method may further comprise delegating step (e) to the third node.

The computer-implemented method may further comprise, by way of the first node: receiving, from the second node, an acceptance notification indicating an acceptance of the proposed automated tagging request; and cryptographically validating that the acceptance notification from the second node includes a second digital signature associated with the second node, wherein the validating step (c) is conditional on a valid second digital signature.

In the computer-implemented method, the proposed automated tagging request may further comprise one or more of: a third node identifier associated with the third node; a third digital signature associated with the third node; and a third node class identifier associated with a class of nodes of the third node.

In the computer-implemented method, the first node may be associated with a first private data store and the method further comprises storing one or more of the proposed automated tagging request and the program instructions including the algorithm in the first private data store.

The computer-implemented method may further comprise, by way of the first node, sending a first encrypted private message, comprising the program instructions including the algorithm, to the third node.

There is also provided a computer-implemented method for determining the eligibility of a digital asset associated with a unique identifier for a transaction, the method comprising, by way of a third node including a third processing device and memory: receiving input data recorded on a distributed ledger from at least a first input data source; executing program instructions including an algorithm that, based on the input data, associates one or more eligibility tags with the unique identifier of the digital asset, the one or more eligibility tags indicating the eligibility of the digital asset for the transaction; recording a representation of the one or more eligibility tags associated with the unique identifier of the digital asset to the distributed ledger; and communicating, by means of a private secure channel to a first node and/or a second node, an eligibility tag notification providing data representative of the one or more eligibility tags.

In the computer-implemented method, communicating the eligibility tag notification may further comprise: sending a second encrypted private message including the eligibility tag notification to the first node and/or second node.

The computer-implemented method may further comprise recording a cryptographic representation of the one or more eligibility tags to the distributed ledger.

In the computer-implemented method, the cryptographic representation of the one or more eligibility tags may comprise a hash of the one or more eligibility tags recorded on the distributed ledger, or the one or more eligibility tags recorded on the distributed ledger in encrypted form.

The computer-implemented method may further comprise validating a first digital signature of the first node and a second digital signature of the second node associated with the program instructions, wherein validity of the program instructions is conditional on the validity of the first and second digital signatures.

The computer-implemented method may further comprise storing the program instructions in a third private data store associated with the third node.

In one example of the computer-implemented method, further additional input data sources may include: a public data source to provide public input data; and a proprietary data source to provide proprietary input data, and wherein the method further comprises validating accuracy of the public input data and/or the proprietary input data with further data of a further input data source.

In the computer-implemented method, validating the accuracy of public input data and/or proprietary input data may include a comparison of respective cryptographic hashes of the data.

The computer-implemented method may further comprise: receiving, from the first node, a request for a transaction involving the digital asset; determining the unique identifier associated with the digital asset; determining, if any, one or more eligibility tags associated with the unique identifier; and determining authorisation for the transaction based on the one or more eligibility tags; wherein based on successful authorisation, the method further comprises: recording the transaction in the distributed ledger.

In the computer-implemented method, the request may further comprise a cryptographic authorisation to transfer control of the digital asset from the first node to the second node based on occurrence of a specified transaction condition, wherein the method further comprises: monitoring input data from the first input data source, and wherein based on identification of an occurrence of the specified transaction condition, control of the digital asset is transferred to the second node.

In the computer-implemented method, the unique identifier may be associated with a control tag indicating a node having control of the digital asset.

The term “digital asset” includes but is not limited to a digital embodiment or representation of an established asset class, a native digital asset (e.g., Bitcoin, ETH, or any other cryptocurrency or digital token), or a digital representation of an obligation, contract, or explicit authorization. The term “digital identity” includes but is not limited to a digital representation of an identity (e.g., human identity).

### BRIEF DESCRIPTION OF DRAWINGS

Examples of the present disclosure will be described with reference to the figures below:

FIG. 1 illustrates an example system for tagging of a digital asset;

FIG. 2 illustrates an example of a transaction between a first node and a second node, as well as interaction of a third node, to determine and associate an eligibility tag with a digital asset;

FIG. 3 is a flow diagram illustrating a method of proposing automated tagging of a digital asset;

FIG. 4 is a flow diagram illustrating steps that can be performed by the third node for automated tagging of a digital asset;

FIG. 5 is a flow diagram illustrating a method of proceeding with a transaction involving a tagged digital asset;

FIG. 6 is a representation of a unique identifier and tags associated with a digital asset;

FIG. 7 is another example of a system for tagging a digital asset;

FIG. 8 illustrates examples of a unique identifier associated with digital asset tags;

FIG. 9 illustrates an example of a unique identifier;

FIG. 10 is an example of code to associate a unique identifier to a digital asset;

FIG. 11 illustrates a schematic example of a distributed-ledger platform architecture that can be used for tagging a digital asset, the architecture including nodes in the distributed network, with messaging, API, and additional node details shown;

FIG. 12 is an example of code to associate industry-wide tags to a unique identifier;

FIG. 13 is an example of code to associate proprietary tags to a unique identifier;

FIG. 14 is an example of code for proposing an eligibility schedule for automated eligibility tagging associated with digital assets tied to respective unique identifiers;

FIG. 15 is an example of code, including a specified algorithm, for eligibility tagging of digital assets associated with respective unique identifiers;

FIG. 16 is an example of code for an eligibility tag of a digital asset associated with a unique identifier, which can include program instructions for conducting a transaction with the digital asset based on the asset's eligibility for use in the transaction;

FIG. 17 is a flow diagram of a process of the example described in FIGS. 12 to 16;

FIG. 18 is a schematic of an example of a system performing an exemplary method of digital asset tagging where the third node, public data source and proprietary data source are separate, with respective private data stores, and communicate with a global synchronization log;

FIG. 19 is a schematic of another example of a system performing a method similar to FIG. 18, but where the third node is also a public data source;

FIG. 20 is a schematic of another example of a system performing a method similar to FIG. 19, but where one of the public data sources is also one of the proprietary data sources;

FIG. 21 illustrates a schematic of several nodes in a distributed computer network;

FIG. 22 illustrates an exemplary distributed ledger network with a plurality of nodes;

FIG. 23 illustrates a structure of a blockchain;

FIG. 24 illustrates an exemplary Merkle Tree data structure;

FIG. 25 illustrates an exemplary efficient lookup of data in a Merkle Tree;

FIG. 26 illustrates an exemplary computer node that can be used in embodiments of the disclosure; and

FIG. 27 illustrates an exemplary process for optimizing and allocating a digital asset in a collateral transaction.

### DESCRIPTION OF EMBODIMENTS

The present disclosure relates to a distributed ledger implementation for determining eligibility of a digital asset for a transaction. Below, the disclosure first provides exemplary distributed ledger implementations that can be utilized with the aforementioned digital asset tagging system, and subsequently a process and apparatus for tagging of digital assets in a distributed manner (e.g., to determine a digital asset's eligibility for a transaction).

A distributed ledger is a record of transactions or other data, which exists across multiple distinct entities in a network. The ledger can be wholly replicated across participants, or segments can be partially replicated across a subset of participants. In either case, the integrity of the data is ensured in order to allow each entity to rely on its veracity and to know that data they are entitled to view is consistent with that viewed by others entitled to view the same data. This makes the distributed ledger a common, authoritative prime record—a single source of truth—to which multiple entities can refer and with which they can securely interact.

Distributed ledger technologies (“DLT”) have expanded beyond mere transaction registries to include other forms of data and encoded business logic, sometimes referred to as “smart contracts”. This means that not only does the technology synchronize the record of who owns what, but also provides an automated common workflow for processing that data, ensuring that the results of agreements are processed in the same, mutually agreed manner

Several examples of DLT, which can be utilized with the presently-disclosed inventive concepts, are described below. The first example is an implementation that has a platform architecture, which includes a distributed ledger having a global synchronization log (GSL) and private contract store (PCS). The ledger may operate in conjunction with encoded business logic (e.g., smart contracts), in a particular example with a modelling language developed by the Applicant referred to as the Digital Asset Modelling Language (“DAML”). Certain aspects of DAML are described in more detail in WO 2017/189027 and WO 2017/187394, while certain aspects of a distributed ledger as described above can be found in WO 2018/013124 and WO 2018/013934, the disclosures of which are hereby incorporated by reference herein in their entireties. The second example is an alternative implementation of DLT that may be used with the presently-disclosed inventive concepts.

### A. Distributed Ledger Architecture

A first example of a distributed ledger that can be used along with the presently-disclosed inventive concepts maintains confidentiality while allowing for the same data integrity assurances of typical blockchain solutions. This can be achieved by the parties involved physically segregating and storing locally confidential contractual information, and sharing a globally replicated log of only fingerprints, or “hashes”, of sensitive data and execution commitments. These hashes are one-way cryptographic functions which can be proven to accurately match a party's data, but do not contain any information about the confidential data itself nor the parties involved.

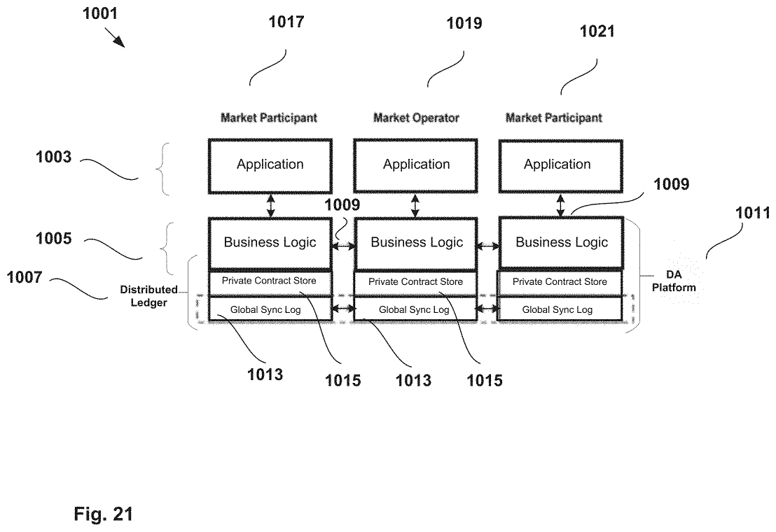

The distributed ledger can be implemented by way of a system 1001 as shown, for example, in FIG. 21. For simplicity's sake, the system 1001 can include multiple layers, such as an Application layer 1003, a Business Logic Layer 1005, and a distributed ledger 1007 layer as illustrated in FIG. 21. Each layer can have its own communication channels 1009. The distributed ledger 1007 can be a permissioned ledger, meaning it is a ledger accessible (for reading or for writing) only by known and pre-approved parties. This differs from a permissionless ledger, where anyone can read or write to the blockchain. The distributed ledger 1007 can include multiple subcomponents, including a Global Synchronization Log (“GSL”) 1013 and a Private Contract Store (PCS″) 1015. The PCS 1015 can, in an example, be a private data store that is segregated from the GSL 1013. By segregated, it is meant that data included in the PCS 1015 is not recorded in the GSL 1013, but rather is kept in a separate, private data store that can be segregated from the GSL 1013. As explained in more detail below, the use of a PCS 1015 can serve to enhance privacy of the distributed ledger for participants in the network.

### (i) The Distributed Ledger 1007, GSL 1013 and PCS 1015

The system 1001 can maintain privacy for participants by concealing private data from other participants in the PCS 1015 while providing a GSL 1013 with public data which can be used to verify information and the integrity of information.

Unlike a network of segregated ledgers that lacks a global arbiter of truth where the system cannot guarantee network participants integrity of the complete set of relevant data, the present disclosure can utilize a GSL 1013, which can maintain confidentiality of the physically segregated ledgers (such as each party's individual PCS 1015) while also serving as a global arbiter of each PCS 1015.

For example, the GSL 1013 can be a shared and globally replicated log that allows for private data stored in one or more PCSs 1015 to be synchronized. In a sense, the GSL 1013 can provide a mechanism by which PCSs 1015 can maintain accurate and up to date data. It is not intended in this disclosure that the GSL 1013 necessarily causes an update of data stored in the PCS 1015 to occur (although it may in some examples). Rather that the GSL 1013 is a means by which a PCS 1015 can be made to be consistent with the public data on the GSL 1013, as well as the private data of other participants (e.g., stored in another PCS 1015). If a node (or participant in communication with a node) determines there is private data that needs to be updated, then the node can request such data. Further synchronization does not necessarily mean that a PCS 1015 is to store the same data as another PCS 1015 (such as that of another node), rather that private data stored in the PCS 1015 is provably consistent with the public data in the GSL 1013 and that inconsistencies with the public data may be flags to the nodes and/or participants that private data should be updated.

Although this system 1001 can be used for synchronization of any kinds of private data, in the context of the present disclosure it is used as a synchronized system for tagging digital assets for determining the eligibility of such digital assets for certain transactions. The details concerning tagging of digital assets for purposes of determining eligibility of such digital assets for certain transactions is discussed in more detail below.

### (ii) Nodes and Participants in the System 1001

In the present disclosure, reference is made to a node in a number of contexts. It is to be understood that a “node” can be a computer or system that interacts with a computer and in some way interfaces with the distributed ledger. Nodes can be operable in different modes including but not limited to: Reader Mode, Writer Mode and Auditor Mode. Each of these modes can give a different level of access to the GSL 1013 and associated PCS 1015 of the distributed ledger 1007.

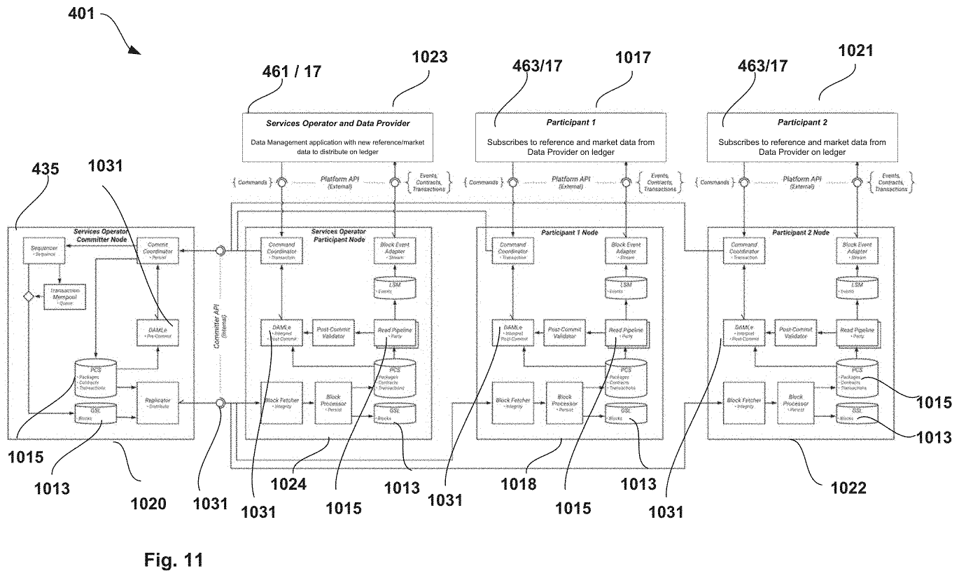

As illustrated in FIG. 11, a node 1018, 1020, 1024 may be itself, or connected to, one or more participants 1017, 1019, 1021, 1023. There can be several types of participants in the system 1001.

A network participant 1017, 1021, 1023 can be a participant in the system that operates a node 1018, 1022, 1024. A participant may be considered a direct participant because it has direct access to read or write to the GSL 1013. In the example of a financial market, there may be market operators 1019, 1023 that operate nodes 1020, 1024 and may also be responsible for maintaining the rules of the market. Market operators 1019, 1023 may govern access to the GSL 1013. This globally replicated log can be a permissioned ledger, meaning it is a ledger accessible (for reading or for writing) only by known and pre-approved nodes with associated participants.

Another type of participant can be an indirect participant. The indirect participants may not operate a node and therefore they may connect to the network through interfaces run by others. Indirect participants can delegate actions on the GSL 1013 to a third party who interacts with the GSL 1013 on their behalf.

Private data can be data that is private and confidential to a participant and where the node associated with the participant maintains privacy for the participant. It is to be appreciated that private data of a participant may be stored in confidence, with the authority of the participant, by other nodes. The private data may be stored in a respective PCS 1015 of a node to maintain the data's confidentiality.

Each network participant 1017, 1021, 1023 can have its own PCS, which contains all validated contracts to which the participant is a party. In this context, the term “contracts” refers to business logic, including transaction parameters, rights and obligations, reflecting the encoded terms of legal agreements by which participants are bound. Business logic can be composed using DAML, and thus, it can include program instructions that are representative of legal or other agreements between participants to the network. Thus, program instructions that can be executed by the node can be stored in the node's PCS 1015. The PCS 1015 can be stored locally and only contain those contractual agreements that the participant is entitled to store and view. The PCS 1015 can be a durable store of the codified contractual relations between parties. It may not process the executable business logic itself, which can be performed at the Business Logic Layer 1005. In other words, the Business Logic Layer 1005 can execute the program instructions constituting the contractual relations between the parties, as opposed to such execution happening in a node's PCS 1015. The PCS 1015 can contain a historical record of all executable contracts (both active and inactive) pertaining to a participant, but this segment of the distributed ledger, in some examples, cannot be constructed from the contents of the PCS 1015 alone. To do this, in certain examples, contracts within the PCS 1015 may be paired with corresponding active evidences in the GSL 1013.

When a node 1018, 1020, 1022, 1024 is operable in a reader mode referred to herein as a reader node, the reader node can become a network node that acts on behalf of participants that might be involved in some contracts or for supervising authorities. The reader node may monitor for notifications for its served participants on the GSL 1013, and may aggregate a partial database of private data. In some examples, it may be desirable that some network participants only have reader mode permissions—for example participant 1017 and corresponding node 1018 may only read the GSL 1013 to verify private data.

When a node 1020, 1024 is operable in a writer mode, referred to herein as a writer node, it can record evidence into GSL 1013. The writer node may also guarantee the contradiction-less recording of evidence and, as a consequence, can have full access into private data that it records as public data. The role of the writer node might be shared by several nodes, such that a write to the GSL 1013 requires joint authorization by them in certain scenarios. In some examples, this joint authorization is arrived at using a consensus protocol, as detailed below. In other examples, a participant who is an operator 1019, 1023 might run a node 1020, 1024 that is both a writer and a reader node in order to be able to submit data on its own. Alternatively, a participant who is an operator may operate multiple separate nodes: one of which can be a writer node, the other of which can be a reader node.

A third mode is that of an “auditor” node. An auditor in the present disclosure can be a node authorized to run in auditor mode, which can have access to private data for the purposes of determining the integrity of at least part of the data in the system 1001. An auditor may have partial access to private data to ensure the integrity of the GSL 1013 is maintained. An auditor node may be associated with an auditor participant (such as an official auditor) who utilizes the auditor node to perform integrity checks on the data in the system. It is to be appreciated that the “auditor” node may be associated with participants that have an interest in ensuring the integrity of the data such as a regulatory authority, market operator, or other authorized person.

(iii) DAML Contract and Data Propagation

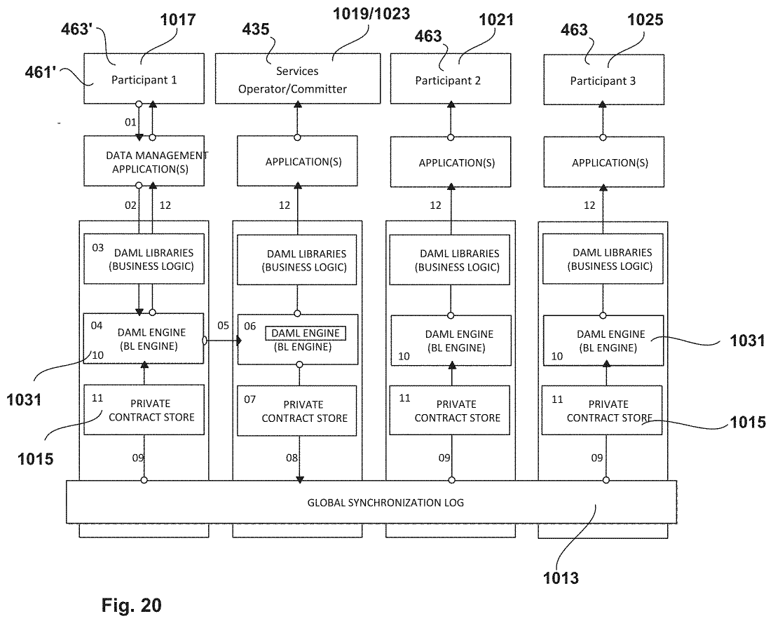

The process of a node committing a DAML contract to the distributed ledger 1007, or updating data stored in a DAML contract or the DAML contract itself, is described below with reference to FIGS. 11 and 20. It is to be appreciated that such process can be utilized to deploy initial DAML tagging and/or eligibility contracts, as described herein, and/or update data in DAML tagging and/or eligibility contracts or the DAML tagging and/or eligibility contract itself. By updating a DAML contract itself, it is meant that a new, updated version of the DAML contract is deployed to the network in place of a prior DAML contract that has been archived, as described herein.

First, when data is available, a node(s) of the respective participants 1017, 1019, 1021, 1023, 1025 can send a DAML Command via the Platform API of FIG. 11 to its DAML Execution Engine (“DAMLe”) 1031, which is interpreted by DAMLe 1031 and translated into a transaction(s)—i.e., Steps 01-04 of FIG. 20. A DAML Command can constitute an API request (e.g., to the Platform API of FIG. 11) to execute certain DAML program instructions or code. In that sense, a DAML Command can constitute an API request that contains a data payload instructing a node(s) to execute certain DAML code and cause an update to the GSL 1013 and/or PCSs 1015 of affected parties. In some cases, this can take the form of updating data in a DAML contract, archiving and replacing a DAML contract with a new version of such contract, or more generally executing code in a DAML contract or series of related DAML contracts that causes state updates to occur to the ledger 1007. The DAMLe 1031 can constitute a runtime environment for execution of DAML code.

The DAML Command and the transaction(s) can then be sent to a writer node(s) 1020, 1024, for instance by way of the committer API 1033 of FIG. 11—i.e., Step 05 of FIG. 20. The transaction(s) can be a message to the writer node(s) 1020 to exercise a choice (e.g., execute a certain code segment) on a contract that has been previously deployed, which defines the rights and obligations of parties in the network. For instance, the message can be to execute a certain code segment in a DAML contract that modifies some data set forth in the DAML contract, executes a transaction (e.g., trade), deploys another DAML contract, or another function capable of being modelled in DAML. The message sent to the committer node(s) 1020 can contain an event that archives an original instance of the DAML contract, and creates a new instance of the DAML contract with new data, or creates an entirely different DAML contract or series of contracts representing the parties' agreement.

Subsequently, the writer node(s) 1020, 1024 DAMLe 1031 can interpret the DAML command in Step 06 to confirm that the transaction it received in Step 05 is valid. For instance, the writer node(s) 1024 can validate, by running the DAML Command received by the node(s) 1018, 1022 in its own DAMLe, among other things, that the message sender has the right to see the original DAML contract, the sender has a right to execute the relevant code segment that forms part of the DAML contract, any new transaction(s) signatories can be bound/placed into an obligable position, the DAML was correctly interpreted, and the most-recent version of DAML was used. The writer node(s) 1020 can also ensure the original DAML contract has not already been archived by a prior transaction, and determine who should be notified of the transaction, once it has been recorded to the distributed ledger 1007 (e.g., GSL 1013 and/or PCSs 1015 of relevant parties).

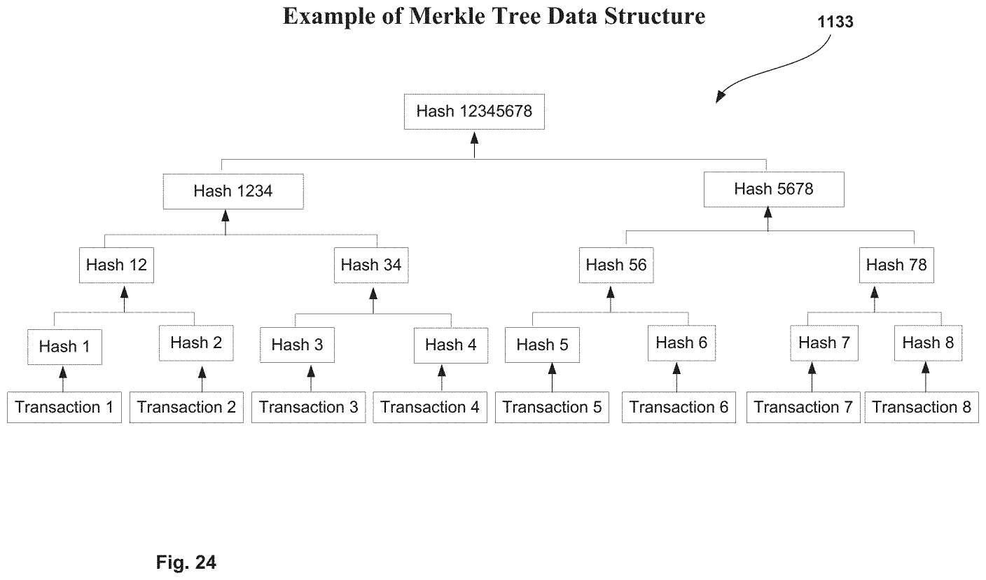

Once validation is complete, the writer node(s) 1020 can store the new DAML contract in its PCS 1015 (Step 07 of FIG. 20) and add the aforementioned transaction to its transaction buffer (Transaction Mempool of FIG. 11) for eventual commitment to the GSL 1013. The transaction can be added to the Transaction Mempool along with other transactions, which ultimately can be combined in a block of the GSL 1013. As detailed above, the transaction can include a cryptographic representation (e.g., a hash) of events caused by execution of a code segment of a DAML contract. These events can include the creation of new DAML contracts or the archival of outdated contracts. Ultimately, the hash of the transaction can be combined with other transaction hashes, which can be hashed once more in a repeating cycle to form a Merkle tree (e.g., similar to as shown in FIG. 24). Either the passage of a set amount of time or exceeding a maximum transaction limit in the Mempool can trigger the writer node(s) 1020 to produce a new block on the GSL and notify relevant participants. The new GSL block can contain a Merkle root (i.e., root of a Merkle hash tree, for instance as shown in FIG. 24) of all the transactions in the current Transaction Mempool, including the transaction created above. The block can also contain a sorted Merkle root of all notifications that may be sent to all relevant parties.

An event can then be broadcast on the GSL 1013 (Step 08 of FIG. 20) and a private notification, cryptographic proof and transaction details sent by the writer node(s) 1020 to appropriate Network Participant node(s) 1018, 1022 (Step 09 of FIG. 20). Whether or not a participant/node in the network receives the aforementioned private notification (Step 09 of FIG. 20) can depend on whether the participant/node is a stakeholder on the new DAML contract. A stakeholder can include (1) obligable parties (e.g., signatories/owners of the contract or parties being bound by the execution of a code segment of the DAML contract), (2) parties having rights (e.g., parties having an ability to execute a code segment of the DAML contract), or (3) parties having observer (e.g., read-only) privileges to the contract. If the participant/node is a stakeholder, it can receive the private notification described above. If not, the participant/node can simply receive the GSL block. The private notification can be a message sent, via a private, optionally encrypted secure channel (e.g., through the Replicator and Block Fetcher of FIG. 11), to stakeholders of a contract that provides:
1. The new GSL block,
2. An archival event of the original DAML contract,
3. The data of the newly created DAML contract,
4. Merkle proofs of the create and archive events, and/or
5. Merkle proofs of the notification of the create and archive events.

As shown in Steps 10-12 of FIG. 20, each stakeholder's DAMLe 1013 can then validate the results (validation process described above in [0095]), store the new DAML contract in its PCS 1015, and then send a DAML event to any connected applications and/or send a notification message to the stakeholder. The DAML event can be sent to any connected applications through an API so that the stakeholder or any of its applications listening for contract changes are notified of a change to the relevant DAML contract.

Using the above mechanism, only actual stakeholders to a DAML contract can be notified of a modification to the contract (e.g., any of the data therein, execution of a code segment in the DAML contract, etc.), and any resulting smart contract is stored in the PCS 1015 of only stakeholders to the DAML contract. As such, using the private notification mechanism provided above, data pertaining to DAML contracts can be kept confidential in ledger 1007.

As detailed more fully below, the system 1001 and ledger 1007 can be utilized with DAML tagging and/or eligibility contracts (disclosed below) to affect transactions in which it is determined that the particular digital asset(s) is eligible for the transaction. The various DAML tagging and/or eligibility contracts can also be updated and kept confidential using the mechanisms described above.

### B. Alternative Distributed Ledger Technology Platform

It is to be appreciated that while an example of a distributed ledger that can be used with DAML contracts (including DAML tagging and/or eligibility contracts) is disclosed above, a different distributed ledger can be utilized with the present inventive concepts to affect tagging and eligibility determinations related to digital assets utilizing a distributed ledger. Such an alternative distributed ledger is disclosed below.

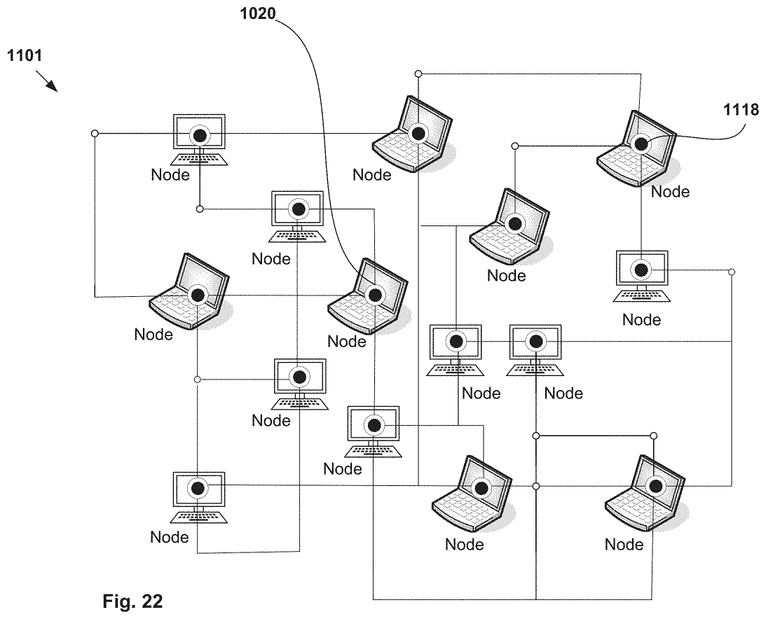

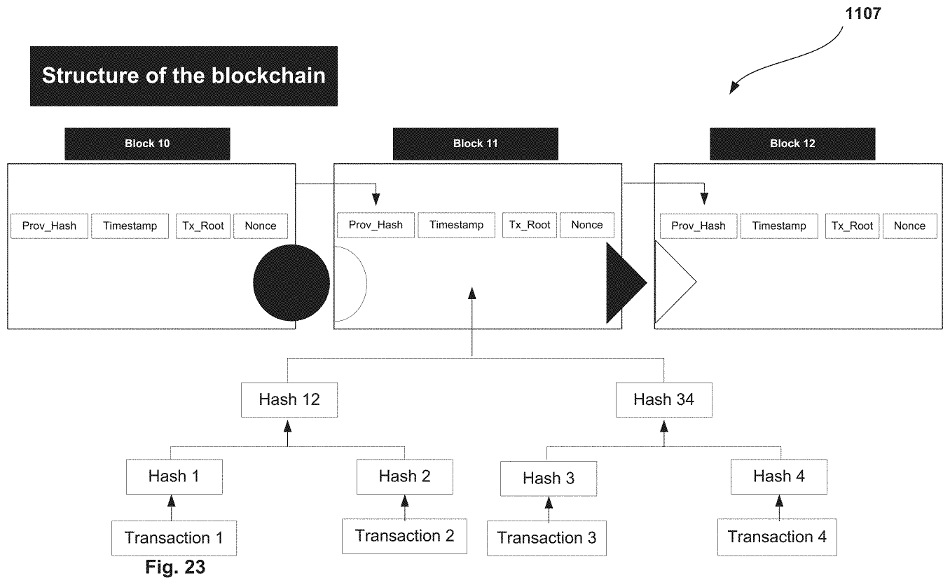

A DLT network 1101 that may be employed with the present inventive concepts can typically include a plurality of nodes, as shown in FIG. 22. The nodes can include “full” or “committer” nodes 1120, which are nodes capable of reading and writing transactions to the distributed ledger or blockchain 1107 (FIG. 23), as the case may be. The nodes can also include “participant” or read-only nodes 1118 that simply can read, but not write, to the distributed ledger 1107 or blockchain. In an example, the network of nodes can be permissioned to control which nodes have the ability to enter the network, in addition to which nodes are read-only or are read/write nodes. A permissioned network can include a network where the ability to run a node, whether read-only or read/write, is subject to approval/permission. A permissioned network can help to provide scalability (e.g., more transactions/sec), achieve privacy, and/or improve security of a distributed ledger, such as ledger 1107. In another example, the network of nodes can be permissionless or a hybrid permissioned/permissionless network. In a permissionless network, anyone has the ability to run a node, whether read-only or read/write, without requiring permission by some entity in partial or full control of the network.

For both permissioned, permissionless or hybrid networks, the network 1101 can utilize a consensus protocol. Examples of consensus protocols that can be used include byzantine-fault tolerant (BFT) consensus algorithms such as, for example, Paxos, Tendermint, Raft, or others, a Proof-of-Work (POW) consensus algorithm (e.g., as used in Bitcoin), a Proof-of-Stake (POS) algorithm, Practical Byzantine Fault Tolerant (PBFT) algorithms, and even other consensus algorithms. A consensus protocol can operate to keep all nodes on the network 1101 synchronized with each other, in terms of the state of the ledger or blockchain 1107. In other words, the consensus protocol can be a protocol where nodes come to an agreement on data that can be written to the ledger or blockchain 1107, so that all nodes in the network 1101 agree on the data—or state—comprising the ledger or blockchain 1107. In certain examples, a consensus protocol can use a peer-to-peer messaging protocol (e.g., over HTTP, RPC, or another messaging protocol) to transmit messages and data between nodes and arrive at consensus. As explained further below, where a consensus protocol is used, it can assist with determining what data should be written to the ledger by all nodes in the network.

It should be appreciated that a consensus protocol can also be utilized with the system 1001 and ledger 1007 detailed previously for the same —e.g., to arrive at consensus as to updates to the state of the ledger 1007.

The network 1101 can also include a runtime environment/execution-engine (e.g., such as DAMLe described above, a virtual machine, etc.) that permits execution of program instructions or (e.g., a smart contract written in DAML) on the network 1101.

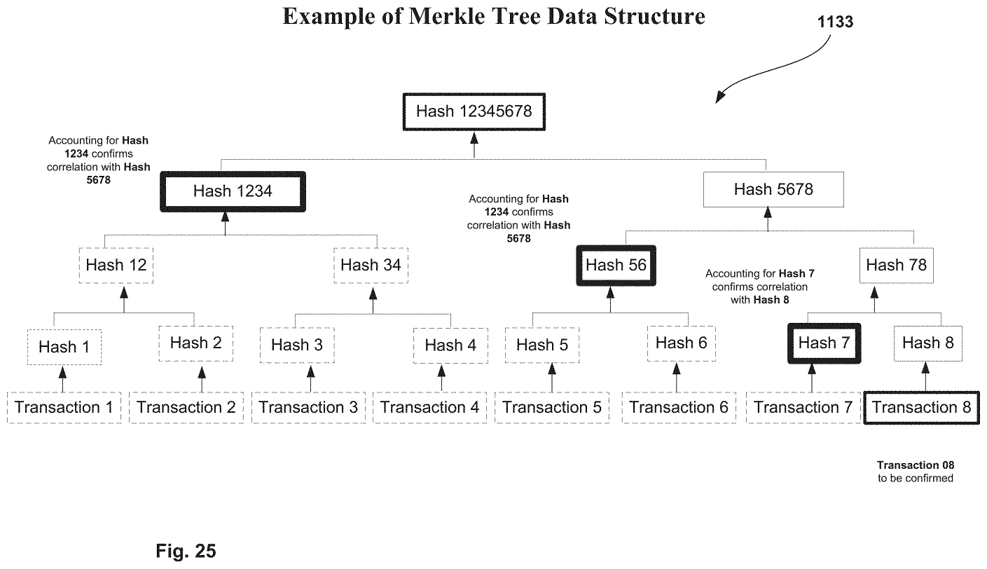

In an example, the data structure of the ledger can be a blockchain 1107, as shown in FIG. 23. A blockchain 1107 can comprise a series of blocks that reference each other to form a “chain”. As shown in FIG. 23, each block that is part of the chain references its prior block by a hash of the prior block (Prev_Hash), and the block can include a Timestamp, a Nonce, and a Tx_Root, which can be the root of a Merkle tree 1133 as shown in FIG. 24. In cryptography and computer science, a hash tree or Merkle tree 1133 is a tree in which every leaf node is labelled with the hash of a data block and every non-leaf node is labelled with the cryptographic hash of the labels of its child nodes. Hash trees allow efficient and secure verification of the contents of large data structures. Merely as an example, a detailed Merkle tree is shown in FIG. 24, and an efficient lookup 1135 of data in a Merkle tree is shown in FIG. 25. Hash trees are a generalization of hash lists and hash chains.

Alternatively, the data structure of the ledger 1107 does not need to be a blockchain and can constitute a distributed ledger with a different data structure.

An exemplary process of writing data to the ledger is now disclosed. It should be understood that the data-writing process may be used with, or interfaced with, DAML applications to update data in DAML contracts, submit transactions, etc.

If a particular node has data to write to the ledger, in the form of an update to a DAML contract, executing a code segment of a DAML contract, deploying a new DAML contract, conducting a transaction in DAML, etc., the node 1018, 1022 can transmit the data to a read/write node for recording on the ledger 1007. Alternatively, if the node 1020, 1024 is itself a read/write node, it can perhaps avoid the transmission step. In an example, the data can be cryptographically signed using a digital signature before it is transmitted to, inter alia, provide data integrity. Once received by the read/write node, the data (e.g., a “transaction”) can be, in certain instances, hashed and combined with other hashed transactions in an efficient data structure, such as the Merkle tree of FIGS. 23 to 25. Incoming transactions/data can be assembled in a “transaction memory pool” of the read/write node and, in certain examples, logically ordered according to timestamp. In other cases, the transactions might not be ordered according to time. The transaction memory pool can be a buffer or another data-storage mechanism for pooling transaction data prior to recording such data to the ledger 1107.

If a blockchain data structure is used for the ledger, as shown in FIG. 23, the Merkle root (Tx_Root) can be supplied in a block along with a hash of the prior block (Prev_Hash), a block timestamp, and a nonce. A consensus algorithm can then be used by the read/write node to communicate peer-to-peer with other nodes participating in consensus to propose the block for entry into the ledger or blockchain 1107. For instance, the consensus algorithm might rely on a voting process amongst a set of nodes referred to as “validators”. A block can be said to be committed by the network when a two-thirds (⅔) majority of validator nodes have cryptographically signed and broadcast commits for a particular block. When enough votes for a block are received, it can be committed to the ledger 1107 along with all the block's transactions. Of course, other consensus mechanisms (described above) can be used to determine whether to commit a block to the ledger 1107.

In a permissioned distributed ledger, particular nodes can be granted permission to commit blocks to the distributed ledger 1107.

In certain examples, privacy-preserving features can also be used with the distributed ledger or blockchain 1107. For instance, as in the system 1101 and ledger 1007 detailed above, data stores that are accessible only to a specific node (e.g., PCSs 1015) can be segregated/kept private from the public-facing portion of the distributed ledger or blockchain 1007 (e.g., GSL 1013) and/or other nodes. The public-facing portion of the distributed ledger or blockchain 1007 (e.g., GSL 1013) can then be used to ensure that the private data stores (e.g., PCSs 1015) of logically-related nodes (e.g., those who have engaged in a DAML contract) are consistent, with respect to DAML contracts that relate specifically to the parties.

Other privacy-preserving techniques can include encrypting data on-chain or in the ledger, such that the encrypted data is only readable by those with the required keys. Alternatively, advanced cryptographic techniques such as Zero-Knowledge Proofs (e.g., zkSNARKs, zkSTARKs, Buletproofs, etc.), ring signatures, or other mechanisms can be used to provide confidentiality to transactions as a whole or certain portions of transactions (e.g., transaction amount).

### 1. Overview of the System

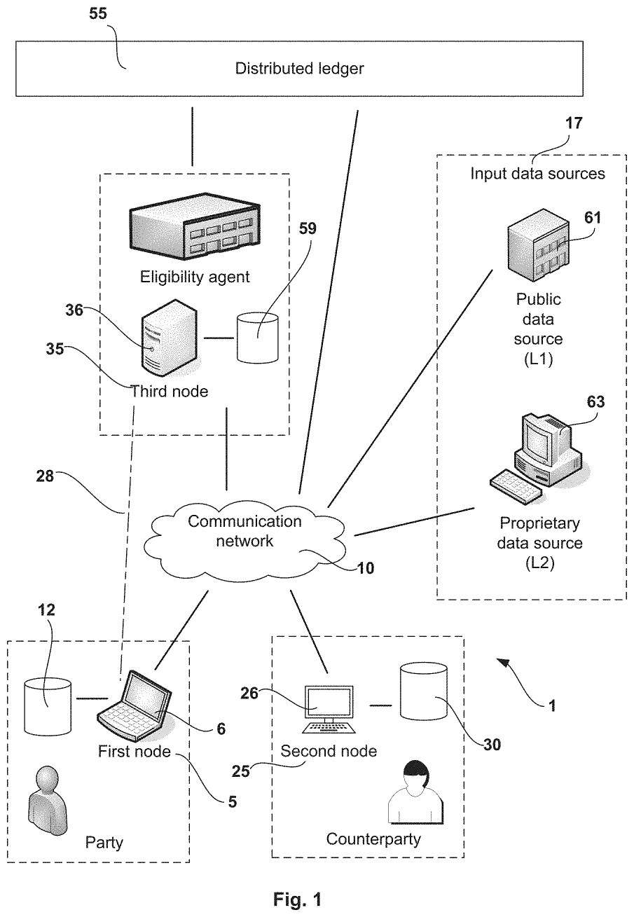

FIG. 1 illustrates an example of a computer system 1 for tagging a digital asset 3. The system 1 can include a first computer node 5 that is in communication, via a communication network 10, to a second computer node 25 and a third computer node 35. Each of the computer nodes 5, 25, 35 can have a respective processing device 6, 26, 36 and memory and private data store 12, 30, 59. The system 1 may also include a distributed ledger 55 that can record data pertaining to certain qualities or characteristics of the digital assets 3. In addition, input data sources 17 can provide input data 15 relevant to one or more of the digital assets 3. The input data sources may include a public data source 61 for publicly available, market-wide data and/or a proprietary data source 63 for proprietary data that is proprietary or available (e.g., exclusively) to certain participants.

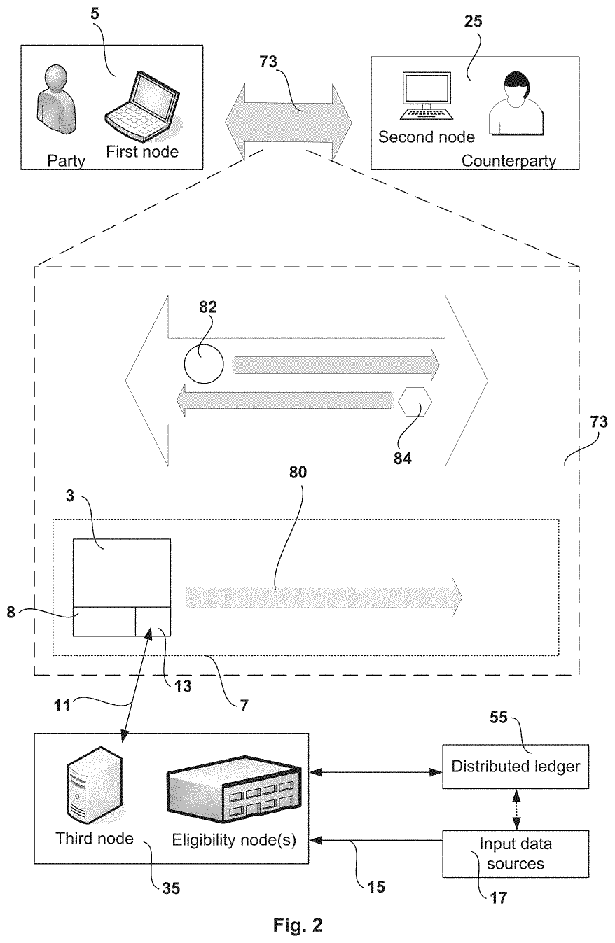

In a non-limiting example discussed below, the computer system 1 can be used for a transaction 73 involving the digital asset 3 between two (2) participants, as shown in FIG. 2. The participants can include a party associated with the first node 5 and a counterparty associated with the second node 25. A third participant can be associated with the third node 35, who may be tasked with performing actions related to the transaction 73. In one example, the third node 35 can be tasked with associating an eligibility tag 13 to a unique identifier 8 of a digital asset 3. In a more specific example, the third node 35 can be configured to determine to determine the eligibility of the digital asset 3 for a certain transaction 73 based on input data 15. Thus, the third node 35 can be considered as an eligibility node or agent. In an example, the transaction 73 can be a transaction in which the digital asset 3 is provided as collateral for the exchange of a tangible asset or a second digital asset, it can be a transaction that involves the exchange of multiple digital assets 3, or another transaction.

The examples disclosed herein can provide a mechanism for tagging digital assets 3 with information that is, without limitation, publicly available, available to specific participants in a network, privately available to a specific participant or entity, and/or automatically tagged based on program instructions 11. The asset tags 13 can be stored within a smart contract or series of smart contracts that are used to determine, for instance, the eligibility of a digital asset 3 for use in a transaction. This may include the eligibility of the digital asset 3 as collateral to a transaction 73 that involves other assets and obligations 82, 84.

The technical system and mechanisms described herein may be applied to an example situation where the digital asset 3 is collateral 80 in relation to obligations, such as repayment obligations, in a transaction 73. As illustrated in FIG. 2, the party associated with the first node 5 can borrow a digital asset 84 from a counterparty associated with the second node 25. As part of the transaction 73, the party may have an obligation to make repayments of a digital asset 82 to the counterparty. As security, the party can pledge a digital asset 3 as collateral 80. If the party defaults on its repayment using digital asset 82, the digital asset 3 as collateral 80 can be transferred to the control of the second node 25 associated with the counterparty. It is to be appreciated that the preceding transaction is merely an exemplary use case of the digital-asset tagging system of the disclosure, as such system can be used to determine the eligibility of a digital asset 3 for different types of transactions between nodes 5, 25.

The system 1, and nodes 5, 25, 35 of the system 1 described above, can perform respective computer-implemented methods to determine an asset's eligibility and to associate eligibility tags 13 with the digital asset 3. This will now be described in detail below.

### 2. Proposing Automated Tagging of a Digital Asset

A first party may propose a transaction 73 with a counterparty, whereby the transaction can involve one or more other assets and obligations 82, 84. To minimise risk, which may be a business and/or technical risk of default or non-performance, the first party may be required to provide a digital asset 3 as collateral. Whether that digital asset 3 is eligible collateral can depend on a variety of attributes from a variety of disparate input data sources 17. Therefore, the first party and its counterparty (and potentially other participants) may need to agree on eligibility criteria for the digital asset 3 to serve as collateral. The present disclosure may provide an automated, distributed mechanism to objectively update the eligibility of a digital asset for a transaction, along with an immutable record of the digital asset's eligibility for the transaction.

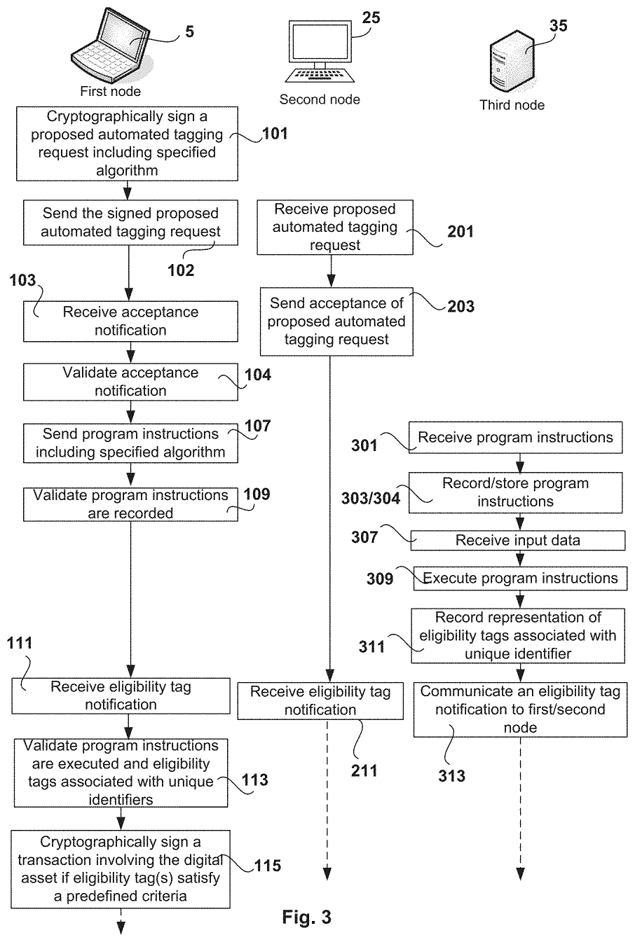

The first party, through the first node 5, can propose an automated tagging request 7 related to the digital asset 3, as shown in FIG. 3. The automated tagging request can include a specified algorithm 11 that is configured to determine at least one eligibility tag 13 based on input data 15. To activate the proposal with the counterparty, the first node 5 may cryptographically sign 101 the automated tagging request 7 with a first digital signature 41 associated with the first node 5. In one example, the digital signature 41 involves an asymmetric public key and private key pair where the private key is used for the digital signature and the public key is used for validating the digital signature.

In some examples, the proposed automated tagging request 7 may include information to allow identification of a third node 35 that is tasked with tagging the digital asset 3. For example, this may include identifying a collateral agent associated with the third node 3. Accordingly, the proposed automated tagging request may include one or more of: a third node identifier 45 associated with the third node 35; a third digital signature 47 associated with the third node 35; and a third node class identifier 49 associated with a class of nodes 51 of the third node 35.

The first node 5 can then send 102 the proposed automated tagging request 7 to the second node 25. The second node 25, on receiving 201 the proposed automated tagging request, can present the proposal for the automated tagging to the counterparty. In particular, the specified algorithm 11 can be presented to the counterparty for approval. If acceptable, the second node 25 may cryptographically sign the proposed automated tagging request 7 with a second digital signature 43 associated with the second node 25.

The second node 25 can then send 203 an acceptance notification 19 indicating acceptance 21 of the proposed automated tagging request 7. In some examples, the acceptance notification 19 includes the proposed automated tagging request 7 signed with the second digital signature.

Practically, in an example, the second node 25 can approve the automated tagging request 7 including the specified algorithm 11 for determining an eligibility tag 13 by executing program instructions (e.g., a code segment(s)) provided in the automated tagging request 7. For instance, the automated tagging request 7 can include program instructions (e.g., a code segment(s)) that are executable upon providing a cryptographic signature (e.g., a digital signature) of the second node 25. In some cases, the cryptographic signature of the second node 25 is required for execution of the code segment(s). The program instructions (e.g., code segment(s)) can include instructions that, when executed, accept the proposed automated tagging request 7 including the specified algorithm 11 for determining an eligibility tag 13 related to various digital assets, records such acceptance to the distributed ledger 55, and/or sends 203 the acceptance notification 19.

The first node 5 can receive 103 the acceptance notification 19 and may cryptographically validate 104 the acceptance notification 19. This may include validating that the acceptance notification 19 includes a valid second digital signature 43 associated with the second node 25 and/or that the program instructions (e.g., code segment(s)) providing the second node's 25 acceptance were validly executed by the second node 25 and not another node. Once validated, the first node 5 can confirm that the counterparty has accepted the proposed automated tagging request 7.

In some examples, the first node 5 may store one or more of the (signed and/or unsigned) proposed automated tagging request 7, the specified algorithm 11, the program instructions accepting the automated tagging request 7, and the acceptance notification 19 in the first private data store 12 associated with the first node 5.

### 3. Performing Automated Tagging of the Digital Asset by the Third Node

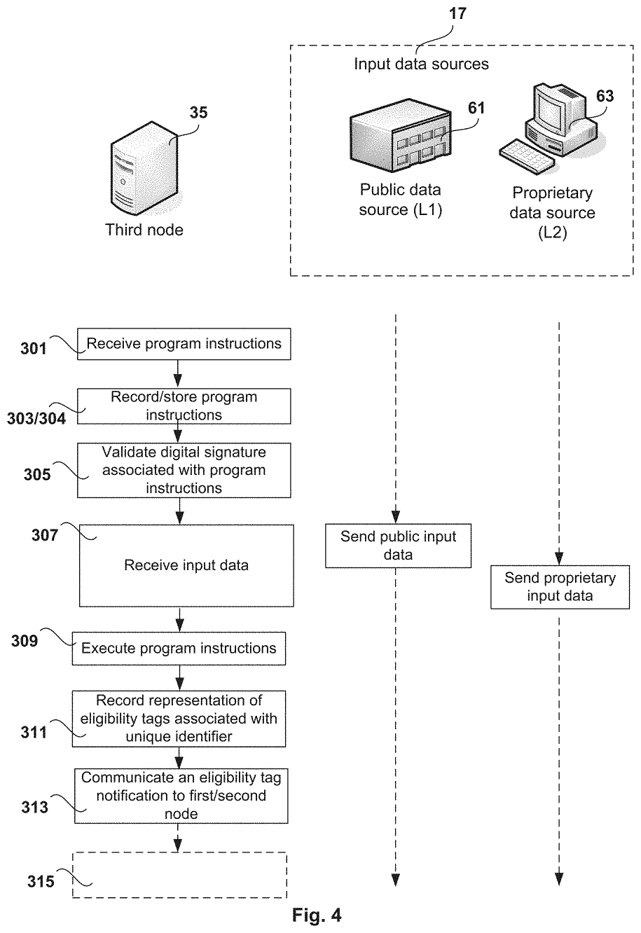

The first node 5 can send 107 program instructions 22 that include the specified algorithm 11 to the third node 35, as illustrated in FIGS. 3 and 4. In some examples, this includes sending one or more of the proposed automated tagging request 7 (that includes the specified algorithm 11), the signed proposed automated tagging request 7 and/or the acceptance notification 19. In some examples, sending 107 the program instructions may include sending a first encrypted private message 23. In some examples, the first encrypted private message 23 may be sent 107 via a private secure channel 28 between the first node 5 and the third node 35.

The third node 35 can receive 301 and record/store 303, 304 the program instructions 22, including the specified algorithm 11. In some examples, the third node 35 records 303 the program instructions to the distributed ledger 55. This may include associating the program instructions with a record of the digital asset 3 on the distributed ledger 55. In some examples, the proposed automated tagging request 7 and/or the acceptance notification 19 is also recorded on the distributed ledger by the third node 35. Alternatively, the program instructions including the specified algorithm 11 can be recorded by the second node 25, as described, for instance, in ¶[0124].

In some examples, the third node 35 stores 304 the program instructions 22, proposed automated tagging request 7, and/or the acceptance notification 19 in the third private data store 59 associated with the third node 35.

In some examples, the first node 5 and/or the second node 25 may validate 109 that the program instructions 22 are recorded 303 on the distributed ledger 55 and/or validate that the third node 35 has stored 304 the program instructions. This can give confidence to the respective parties that third node 35 has received the program instructions 22 for execution.

The third node 35 may validate 305 that the program instructions 22, including the specified algorithm 11, that has been accepted as valid by the first and second nodes 5, 25. In one example, this includes validating 305 the first digital signature 41 of the first node 5 and the second digital signature 43 of the second node 25 associated with the program instructions 22. The validity of the execution of the program instructions may be conditional on the validity of the digital signatures. Therefore, the third node 35 may only be authorised to tag the digital asset 3 in accordance with the specified algorithm 11 if the signatures are valid. The step of validating 305 the execution of the program instructions may be performed before or after the step of recording/storing 303, 304 the program instructions. In some examples, recording/storing 303, 304 the program instructions may be conditional on successful validation 305.

### (i) Receive Input Data

The third node 35 can receive 307 input data 15 from at least one or more input data sources 17. In some examples, the input data 15 may be recorded on the distributed ledger 55 and the third node 35 receives the input data 15 indirectly via the distributed ledger 55. In some examples, the input data sources 17 send input data 15 to the third node 35. In yet another example, the input data 15 may be both sent directly to the third node 35 and also be recorded on the distributed ledger 55.

In yet another example, the third node 35 may receive 307 input data 15 from the input data sources 17. The input data sources 17, or another source or node, may also record a cryptographic hash of the input data 15 on the distributed ledger 55. The third node 35 may then validate the accuracy of the received input data 15 by comparing a cryptographic hash of the input data 15 with the corresponding cryptographic hash on the distributed ledger 55.

In some examples, the third node 35 may also record a record of the received input data 17 on the distributed ledger 55.

The input data sources 17 may further include, but are not limited to, public data sources 61 and proprietary data sources 63.

A public data source 61 can provide public input data 62, which can include information that is widely available to the public and not confidential or proprietary. For example, this may include industry-wide data such as market price, public credit rating, published financial data and examples that are discussed under a separate heading below. Such data may come from a variety of sources and in some examples, the third node 35 may validate the accuracy of public input data 62 by comparing the public input data 62 with further data 66 from a further input data source.

A proprietary data source 63 may provide proprietary input data 65 that is proprietary to a particular participant or group of participants in the network. For example, particular participants may want to provide specific proprietary attributes to a digital asset based on their proprietary research and data analysis. Examples of proprietary data 65 are discussed under a separate heading below. Like public data 62, the third node 35 may also validate the accuracy of proprietary input data 65 by comparing the data with further data 66 from a further input data source.

### (ii) Execute Program Instructions

The third node 35 can be configured to execute 309 program instructions, including the specified algorithm 11, based on the received input data 15. The specified algorithm may 11 process the input data 15 to determine a further attribute for association with the digital asset 3. In one example, this further attribute is the eligibility of the digital asset 3 based on eligibility criteria as defined by the specified algorithm 11, whereby eligibility is determined in conjunction with the input data 15 as input parameters.

In a particular example, eligibility can be based on determining the eligibility of the digital asset 3 as collateral for a transaction or a class of transactions. The result of this determination can include associating one or more eligibility tags 13 to a unique identifier 8 associated with a digital asset 3. Thus, the eligibility tag 13 can allow the first and second nodes 5, 25 to identify the eligibility status of the digital asset 3. This may include the eligibility status of the digital asset 3 for a specific transaction. That is, the eligibility tag 13 can be associated and valid for a specific transaction 73 that was specified in the proposed automated tagging request 7. However, in other examples the proposed automated tagging request 7 may specify that the eligibility tag 13 may be associated with a class (i.e., a group) of transactions or for transactions in general without specifying one particular transaction. This may allow the first and second node 5, 25 to have certain digital assets 3 automatically determined as eligible or not eligible without having to particularise a specific transaction. This may be useful for timing reasons as the nodes may effectively have predetermined or preauthorised digital assets 3 marked as eligible collateral.

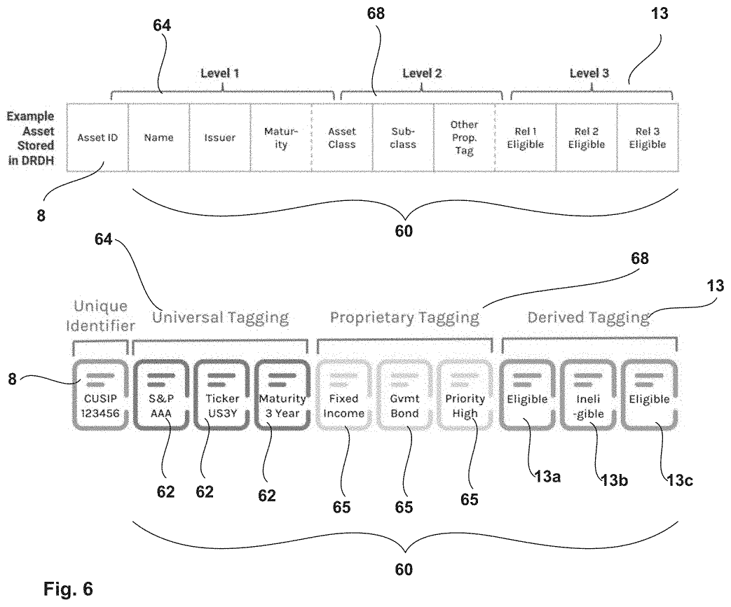

FIG. 6 illustrates exemplary relationships and association of a unique identifier 8 and a digital asset 3 with the determined eligibility tag 13. In some examples, the input data 15 may also have tags 60 associated with the unique identifier 8. This is shown as public data 62 and proprietary data 65 that is also included as public data tags 64 and proprietary data tags 68.

(iii) Record Representation of Eligibility Tags and Communicate to First and Second Nodes

The third node 35 can be configured to record 311 a representation of the one or more eligibility tags 13 associated with the unique identifier 8 of the digital asset 3. In one example, this can include recording the representation to the distributed ledger 55. In a further example, the representation can be a cryptographic representation of the eligibility tag 13 associated with the unique identifier 8 that is recorded on the distributed ledger 55. The cryptographic representation may include a hash of an eligibility tag recorded on the distributed ledger 55. In another alternative, the eligibility tag may be recorded on the distributed ledger 55 in an encrypted form. The encrypted form may include encrypting the eligibility tag 13, associated with the unique identifier 8, with a shared secret key with one or more of the first node 5 and the second node 25. Advantageously, the cryptographic representation of the eligibility tag 13 on the distributed ledger can provide an immutable record whilst maintaining privacy so that only relevant participants can identify and/or verify the eligibility tag 13 that is associated with the digital asset 3.

In some examples, the third node 35 can be configured to record 311 the representation of the one or more eligibility tags 13 in another data store, such as the third private data store 59. In yet another example, the third node can be configured to record 311 the representation of the one or more eligibility tags 13 in a separate data store, accessible to the first node 5 and second node 25, but not to the general public.

The third node 35 can communicate 313 an eligibility tag notification 53 to the first node 5 and/or the second node 25 that provides data representative of the one or more eligibility tags 13. This can serve as notification to the nodes 5, 25 and the respective participants of a determined eligibility tag 13 or change in eligibility tag 13 relevant to the digital asset 3. In some examples, the third node 35 can communicate the eligibility tag notification 53 in a second encrypted private message 57. In some examples, the second encrypted private message 57 may be through a private secure channel 28 with the first node 5 and/or the second node 25.

Although the example of FIG. 1 illustrates a third node 35 as a distinctly separate to first node 5 and second node 25, it is to be appreciated that in some alternatives one or more of the functions of the third node 35 could be executed by one of the first or second nodes 5, 25. For example, the system may be configured so that the first node 5 and/or second node 25 is configured to execute 309 the program instructions, record 311 the representation of the one or more eligibility tags 13 to the distributed ledger 55, and to communicate the eligibility tag 13 to the other node.

### (iv) Validate Execution of Program Instructions and Eligibility Tags

When the first node 5 and/or second node 25 receives 111, 211 the eligibility tag notification 53, this may prompt the nodes 5, 25 to take corresponding action. In one example, the first node 5 and/or second node 25 may want to validate 113 that the program instructions were executed properly and in accordance with the specified algorithm 11 and that the eligibility tags 13 are properly associated with the unique identifier 8. In some examples, this may include the node 5, 25 executing the specified algorithm 11 with respective input data 15 and validating that the results correspond to the results provided in the eligibility tag notification 53. In other examples, this may include the node 5, 25 validating that the eligibility tag notification 53 corresponds to the recorded representation of the eligibility tag 13 and associated unique identifier on the distributed ledger 55.

The first and second nodes 5, 25 may also record the eligibility tag notification 53 (or a corresponding record of the eligibility tag 13) in their respective private data stores 12, 59. This may be used to update their respective private records in relation to the transaction 73 and the digital asset 3.

4. Proceeding with a Transaction 73 Involving a Tagged Digital Asset 3

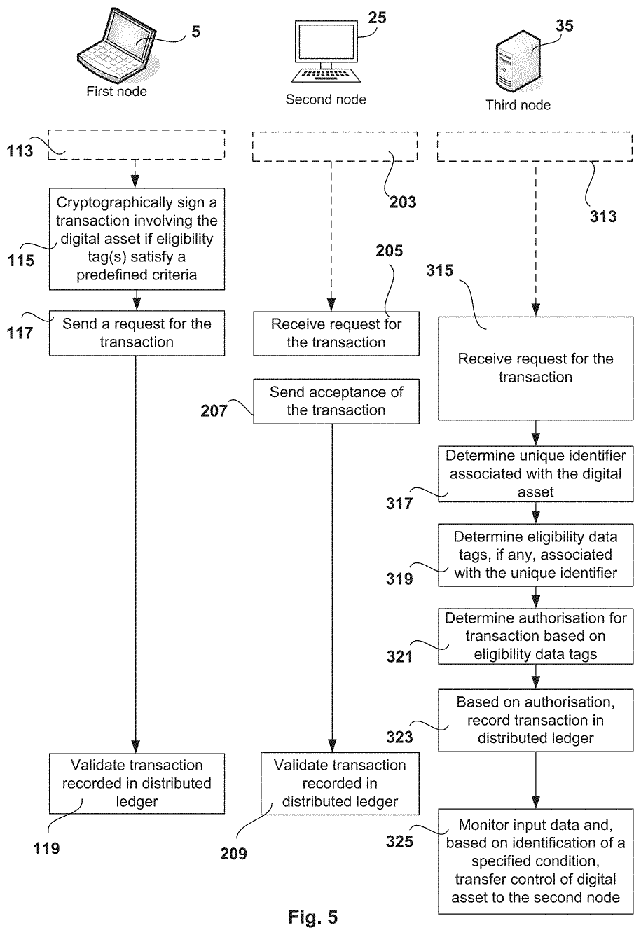

Upon validation 113 of the execution of program instructions and the corresponding eligibility tags 13, the first node 5 and second node 25 may further proceed with a transaction 73 associated with the digital asset 3, as illustrated in FIG. 5. Proceeding with the transaction may include determining that the eligibility tag 13 satisfies a predefined, or other specified criteria. This may include the first node 5 checking their private data store 12 and/or the distributed ledger 55 to determine the eligibility tag 13 of the digital asset 3.

In one example, the eligibility tag 13 may indicate that the digital asset 3 is eligible collateral 80 for the purposes of a transaction 73. Therefore, upon determination that the eligibility tag 13 satisfies the criteria, the first node 13 may proceed to cryptographically sign 115, using the first digital signature 41, a transaction 73 involving the digital asset 3.

In some examples, the step of cryptographically signing 115 by the first node 5 may be delegated to the third node 3. In some examples, such delegation may be achieved with a system of cryptographic key management. One example may include the third node 35 possessing, and having authorisation to use a private key associated with the first node 5.

The first node 5 may then send 117 the signed request 77 for the transaction 73 to the second node 25 and/or the third node 35. The second node 25 may receive 205 the request 77 and if acceptable, digitally sign with the second digital signature 43 associated with the second node 25. The second node 25 may then send 25 the signed acceptance of the request 77 back to the first node 3 and/or to the third node 35. It is to be appreciated that in some alternatives, the second node 25 may initiate the request for the transaction 73 and sign the request 77 before the first node 5.

The third node 35 can receive 315 the request 77 for the transaction 73 from the first node 5 and/or the second node 25. In some examples, the digital signature of the first and second nodes 5, 25 can be validated and, if so, taken as authorisation for the third node 35 to proceed and process the requested transaction 73.

The third node 35 can determine 317 the unique identifier 8 associated with the digital asset 3 which, in turn, is associated with the requested transaction 73. This may include retrieving records from the third private data store 59 and/or the distributed ledger 55. In other examples, the request 77 may contain the unique identifier 8.

The third node 35 can determine 319 an eligibility tag(s) 13, if any, associated with the unique identifier 8. This may involve querying existing records and/or determining the eligibility tags 13 from executing the program instructions in conjunction with input data 15. In the case of querying existing records, this may include querying the third private data store 59 and/or distributed ledger 55. In the case of executing the program instructions, this can involve receiving input data 15 in a similar manner as discussed above in steps 307 and 309.

The eligibility tags 13 can then be used to determine 321 authorisation for the transaction 73. In one example, this may include the third node 35 querying the respective eligibility tags 13 that are specified to be “eligible” for the transaction 73. Referring to FIG. 6, this may include a specified requirement that a first eligibility tag 13 a indicates “eligible”. The other eligibility tags 13b, 13c may also be relevant, but this can depend on the specified requirements. In one example, a second eligibility tag 13b may not be a relevant consideration for the transaction 73 and therefore the transaction may be authorised regardless of the result of the second eligibility tag 13b.

In yet another example, the authorisation for the transaction 73 may be based on other qualities of the eligibility tags 13 or group of eligibility tags 13. For example, the transaction 73 may specify that authorisation for the transaction 73 requires at least two out of three eligibility tags 13 to be marked “eligible”. Referring to FIG. 6, having the first and third eligibility tags 13a, 13b marked as eligible can be sufficient for the third node 3 to authorise the transaction 73.

Based on successful authorisation, the third node 3 may then record 323 the transaction 73. Recording 323 the transaction may include recording the transaction 73 on the distributed ledger 55. In some examples, the transaction 73 can be related to one or more other digital assets or obligations 82, 84. Therefore, records associated with these other digital assets or obligations 82, 84 may also be updated on the distributed ledger 55. In some examples, the record on the distributed ledger may be a cryptographic representation similar to the methods discussed above. The third node 3 may also record the transaction 73 in the third private data store 59.

Furthermore, the third node 3 may communicate a notification of the recorded transaction 73 to the first node 5 and second node 25. In some examples, this may include sending respective encrypted private messages to the nodes 5, 25. This may be via private secure channels 28. In other examples, the nodes 5, 25 may be notified by monitoring the distributed ledger 55 for a record of the transaction 73.

Upon receiving notification of the transaction, the first and second nodes 5, 25 may validate 119, 209 that the transaction has been recorded on the distributed ledger 55. This may include similar validation methods as noted in steps 109 and 113 above.

### 5. Automatic Transfer of Control of Digital Asset Based on Specified Transaction Condition

An example of automatic transfer of control of the digital asset 3 is now described. Turning to the example illustrated in FIG. 2, the first party associated with the first node 5 can borrow an asset 84 from the counterparty associated with the second node 25. As part of the transaction 73, the first party can have an obligation to make repayments of asset 82 to the counterparty, and pledges a digital asset 3 as collateral 80. If the party defaults on the repayment of the assets 82, the digital asset 3 can be transferred to the control of the second node 25 associated with the counterparty.

Referring now to FIG. 5, the request 77 for the transaction 73 may further comprise a cryptographic authorisation to transfer control of the digital asset 3 from the first node 5 to the second node 25 based on occurrence of a specified transaction condition 79. Such a transaction condition may include, for example, defaulting on repayments specified in the transaction 73.

The third node 35 may monitor 187 input data 15 from the first input data source 17 and, based on identification of an occurrence 81 of the specified transaction condition 79, control of the digital asset 3 can be transferred to the second node 25. In some examples, this may include monitoring 187, on the distributed ledger 55, if repayment of asset 82 is made in accordance with the specified transaction condition 79 that may include temporal and quantum conditions for the repayment asset 82.

The above example has been described in the context of the digital asset 3 as collateral 80 for a loan. However, it is to be appreciated that the specified transaction condition 79 may be based on other variables and inputs. Such inputs may be based on, for example, public input data 62 such as market price of an asset, and/or financial instrument. In other examples, it may be based on proprietary input data 65.

In some examples, the cryptographic authorisation to transfer control of the digital asset 3 from the first node 5 to the second node 25 may include transferring partial or intermediate control to the third node 3. In one example, the first node 3 may have delegated authority to the third node 3 to transfer control based on the specified transaction condition. In some examples, this may include the third node 3 having access to a private key associated with the digital asset 3. In another example, the digital asset 3 may be transferred to multi-signature control whereby transfer of the digital asset 3 is based on agreement by specified nodes that the specified transaction condition 79 has occurred, and signature by the specified nodes can be provided to transfer control of the digital asset to the second node 25.

The advantage of the third node 35 monitoring 325 the input data 15 is that the transfer of control may be automated. That is, the first node 5 and the second node 25 may not be required to actively request transfer of the collateral as the nodes 5, 25 have agreed to the specified transaction conditions 79.

### 6. Control Tag

In some examples, the unique identifier 8 can also be associated with a control tag to indicate the node having control of the digital asset 3. This may be performed as part of the method by third node 35 during execution of the program instructions. In some examples, the control tag is recorded on the distributed ledger 55 in encrypted and/or unencrypted form. In further examples, the control tag may be sent by the third node 3 to the nodes 5, 25 in an encrypted private message. Advantageously, this allows the nodes 5, 25 to keep track of the nodes having control of the digital asset 3 and raise flags if the digital asset 3 has been used, or is attempted to be used, for purposes outside conditions of the transaction 73.

7. Example of a System for Associating Tags with a Digital Asset

A particular example of associating tags with a digital asset 3 is now discussed with reference to FIGS. 6 to 18. Referring to FIG. 6, this includes providing a record of the digital asset 3 that includes a unique identifier 8 and associated tags 60. The tags 60 can be divided into multiple classes, including public data tags 64 that are associated with public input data 62, proprietary data tags 68 that are associated with proprietary input data, and eligibility tags 13 discussed in detail above.

The asset tagging system of the present example can be utilized to identify the eligibility of a digital asset for a transaction, such as for example a collateral transaction, between any number of participant nodes in a network. Existing systems typically use traditional database technology (e.g., a relational or non-relational database) to, for instance, use reference data to determine the eligibility of a particular asset as collateral. As such, participants in a market generally maintain their own database with reference data pertaining to assets being used for transactions in the market, with each database segregated from the other. Further, a participant's reference data database is, in general, not reconciled with the reference database of any other participant, making it difficult to, in a peer-to-peer way, determine the eligibility of an asset for a transaction between participants in in the market. Typically, participants solve this issue by having a central market intermediary (e.g., a collateral agent) make a determination of the eligibility of an asset as collateral between different participants in the market. Because there is no practical mechanism for the participants themselves to agree on the state of, for instance, reference data pertaining to particular assets using a peer-to-peer mechanism, participants must trust a central agent to collate reference data and make a determination of the eligibility of an asset for a collateral transaction on behalf of the participants. This leads to a number of inefficiencies. For instance, the central agent may be using its siloed reference data database to make eligibility determinations for many market participants, resulting in extremely slow processing. Further, if a change in market conditions necessitates making new eligibility determinations, this slow process must be run again, resulting in delays and general inefficiency.

In addition, with existing systems it is technically infeasible to determine, in real time, the eligibility of an asset for a collateral transaction on an asset-by-asset basis in a peer-to-peer way. Thus, when existing systems are faced with the task of completing multiple collateral transactions, each with different eligibility schedules, from one pool of eligible collateral, existing systems will enter an iterative cycle. They test the eligibility of assets in the pool for the first collateral transaction against the eligibility criteria of the first collateral transaction before making the allocation of collateral found eligible for the first collateral transaction. As the allocation of collateral to the first collateral transaction changed the pool of assets, and as the eligibility criteria of the second collateral transaction is different, the systems need to rerun the eligibility testing for the second collateral testing on the remaining pool of assets. This iterative process must be rerun for each sequential collateral transaction. In the event new collateral is added or new collateral transactions are necessary, more iterations are necessary.

This sequential and iterative process brings additional inefficiencies because of the inability of the existing systems to understand the eligibility criteria of any particular asset for any particular collateral transaction until the eligibility criteria for that particular collateral transaction is actually run against the pool. Thus, the existing systems are incapable of predicting the need to reserve assets with limited eligibility for the collateral transactions with narrow eligibility criteria if such collateral transactions are processed later in the sequence. Thus, in the existing system, collateral with broad acceptability (collateral that is more likely to be accepted across a broad range of eligibility criteria of more collateral transactions) is more likely to be allocated first, and not necessarily maximizing the use of such broadly acceptable collateral. The early allocation increase the risk that a subsequent collateral transaction with a narrow eligibility criteria may be unmet as the remaining, unallocated collateral is now not acceptable to the collateral transaction with a narrow eligibility criteria. In such event, existing systems must identify the collateral transaction that originally received the broadly acceptable collateral, rerun the eligibility criteria test for the that collateral transaction to see if any unallocated collateral is eligible for that transaction, initiate a substitution of the newly identified collateral for the broadly acceptable collateral, and, finally, complete the collateral transaction with the narrow eligibility criteria using the returned broadly acceptable collateral.

The iterative nature of the existing systems can drastically affect the ease and speed at which an asset can be allocated as collateral to a counterparty. Last, because assets in existing systems must first be determined to be eligible for a collateral transaction using the slow, batch processing described above, it is also difficult and inefficient from a technical perspective to perform optimizations on assets to determine where an asset should be allocated. Examples of the present disclosure alleviate these issues by providing a distributed, asset-level tagging system as part of a distributed ledger to efficiently determine whether a digital asset is eligible for a transaction on a peer-to-peer basis, and where such digital asset can be best allocated. In a sense, certain examples of the disclosure provide for efficient peer-to-peer eligibility determinations and “self-directed” optimization and/or allocation of the digital asset. By “self-directed”, it is meant that the digital asset is associated with program instructions or a code segment(s), as described below, that allows the digital asset itself to determine where optimally it should be allocated, and to actually allocate itself to a counterparty in an eligible transaction.

The “self-directed” nature of the digital asset alleviates the need for the iterative process of existing systems. Embodiments of the present disclosure may no longer need to query the existing pool of collateral with the eligibility criteria of each collateral transaction again and again to allocate collateral in the sequential processing of each collateral transaction. Because each digital asset is already marked with the collateral transaction for which it is eligible, embodiments of the present disclosure may simultaneously perform the entire allocation of all collateral transactions in a single batch process. The asset tagging and the self-direction provides the system the ability to optimize the use of the available digital assets configuring the allocation of the broadly accepted collateral with the collateral transactions with the narrowest eligibility schedule. Finally, because allocation is completed in one process, there is no need for recalls and substitutions to fix prior allocations that are currently necessary in the current system.

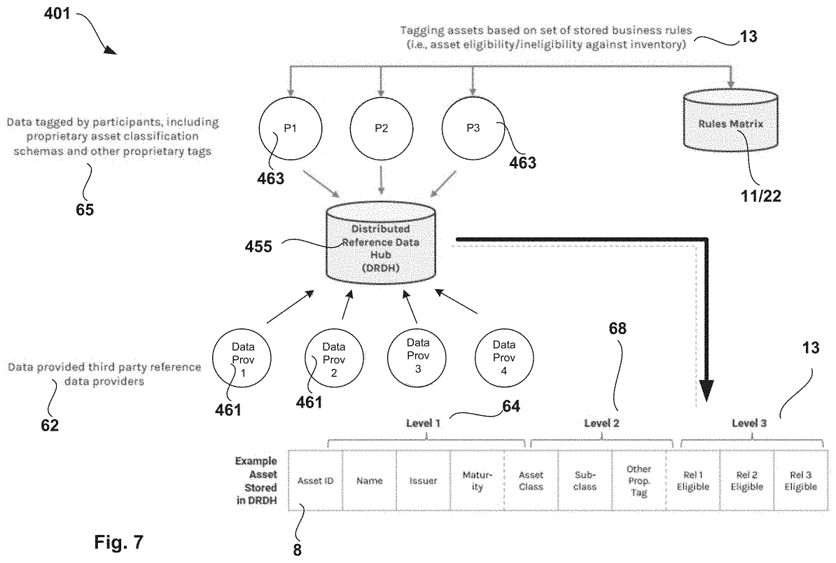

Turning to FIG. 7, it illustrates an exemplary asset tagging system 401 that uses a distributed reference data hub (DRDH) 455, where the DRDH can constitute a distributed ledger 455 that records data pertaining to certain qualities or characteristics of digital assets 3. In an example, the qualities and characteristics of the digital assets 3 can include so-called reference data. The DRDH 455, as detailed below, can be an implementation of a platform offered by the Applicant and described above (that has a distributed ledger 455 including the Global Synchronization Log (GSL) 456 and Private Contract Store (PCS) 455). The DRDH may also be a blockchain or another DLT platform that optionally utilizes a consensus algorithm, as detailed more fully above.

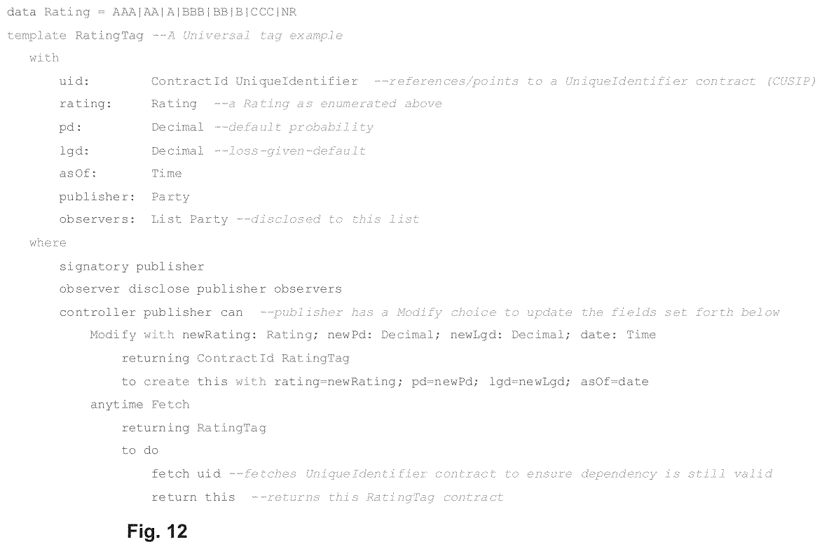

In an example, a language such as the Digital Asset Modelling Language (DAML) offered by the Applicant can be used for the smart contract or series of smart contracts disclosed herein. DAML is detailed in WO 2017/189027 and W02017/187394, each of which is incorporated by reference herein in their entireties. FIG. 7 illustrates different levels or types of digital asset tags 60, 64, 68, 13 that can be employed for determining the eligibility of a digital asset 3 for a transaction. In an example, each different tag category can be represented as a smart contract or series of smart contracts, as shown in the DAML contracts of FIGS. 12 to 16.

### (i) Unique Identifier 8

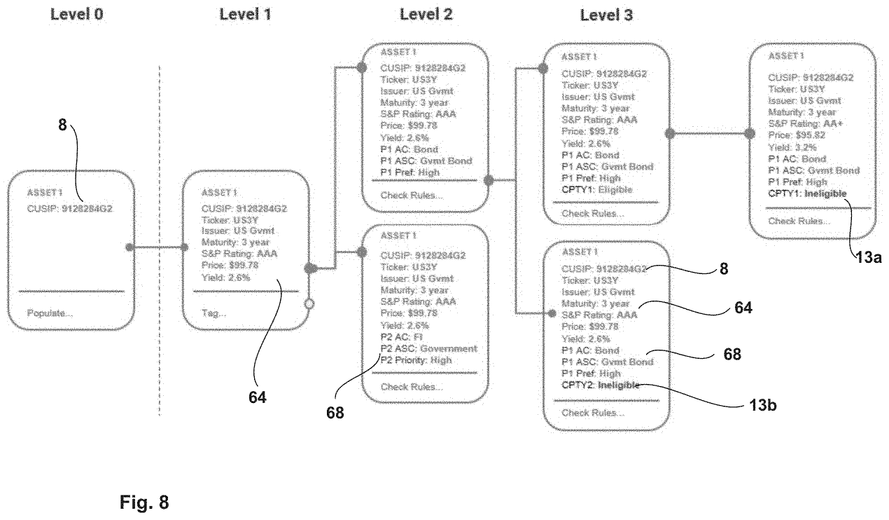

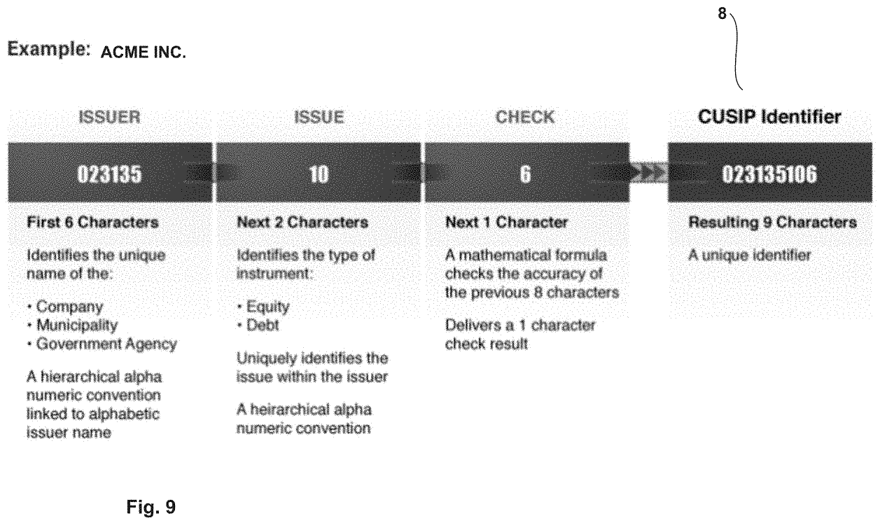

To facilitate sharing of distributed reference data, a unique identifier 8 can be used to tie such reference data to a particular digital asset or digital-asset classification. In an example, the unique identifier 8 can be a domain-specific identifier, which is widely accepted in a given domain The identifier may be a single data field or made up of a composite set of data fields. For example, in the case of financial markets, as shown in FIGS. 8 and 9, the unique identifier 8 may be assigned by the Committee on Uniform Security Identification Procedures (“CUSIP”). A CUSIP can provide identification information for a particular digital asset 3, such as information about an issuer and its issue, as well as a check, as shown in FIG. 9. Such a unique identifier 8 can allow a smart contract(s) to refer or point to a digital asset 3, which may be representative of a conventional asset (e.g., stock, bond, etc.), by a common identifier. However, given that non-U.S. issued securities are not identified by CUSIP, a different unique identifier or a concatenation or union of identifiers may be used, such as an International Securities Identification Number (“ISIN”), Stock Exchange Daily Official List (“SEDOL”), or other unique identifiers for assets, alone or in combination with each other.

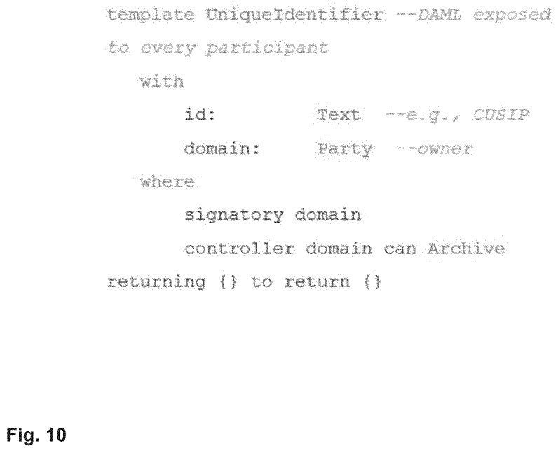

As detailed below, the unique identifier 8 can be provided along with each reference data DAML contract to tie any digital asset tags 60 directly to a particular digital asset 3. FIG. 10 illustrates exemplary DAML that provides a UniqueIdentifier contract 8, which can be used/referenced in other DAML contracts (e.g., as shown in FIGS. 12 to 16).

As used herein, references to a DAML contract can signify program instructions that, as disclosed in more detail above, can be recorded to a distributed ledger (either directly or a cryptographic representation thereof).

### (ii) Market-Wide Data—Public Input Data 62

Market-wide data, such as public input data 62 and respective public input data tags 64, can be a first subset of data tags 60 associated with the unique identifier 8 and the digital asset 3. Examples of market-wide data is shown as Level 1 tags 64 in FIG. 7. In an example, market-wide data can be supplied by public data sources 61 in, for instance, the relevant industry (illustrated as Data Prov(s) 461 in FIG. 7). In an example, in the financial industry market-wide data providers can be ratings agencies (e.g., Moody's, S&P, Fitch, etc.), data aggregators (e.g., Bloomberg), or other market-wide data providers that supply reference data that is generally accepted by the market. Examples of market-wide reference data (i.e., public input data 62 and public input data tags 64) is shown as Level 1 tags in FIG. 7 and can include asset ID, name of the asset, issuer, and maturity. Although certain market-wide reference data is shown, it should be understood that market-wide reference data can also include asset ratings, issuer information, index tickers, listing index, country of issuance, country of risk, market price, etc.

(iii) Proprietary Reference Data—Proprietary Input Data 65

Proprietary reference data, such as proprietary input data 65 and respective proprietary input data tags 68, can be a second subset of data/tags 60 associated with the unique identifier 8 and the digital asset 3. Proprietary reference data can include any data that is proprietary to a certain network participant, and can include but is not limited to data derived from private and/or public data (e.g., L1 tags 64). In FIG. 7, proprietary reference data 65 is illustrated as Level 2 tags 68. Examples of Level 2 tags 68 is shown as asset class, asset subclass, and other proprietary tags at the bottom of FIG. 7. “Other proprietary tags” in FIG. 7 can, for example, include proprietary information such as internal asset ratings/preference, internal asset classification, internal asset sub-classification, material non-public information, liquidity score, allocation score, etc.

### (iv) Derived Data—Eligibility Tag 13

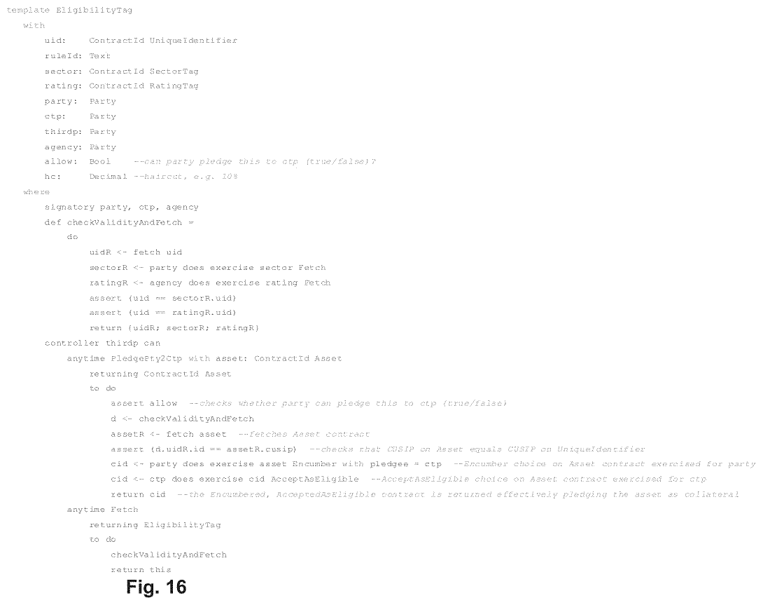

Eligibility of a digital asset 3 for a transaction (e.g., eligibility tag 13), as explained in more detail below, can be computed from proprietary, market-wide, and/or other data and constitute a third subset of data/tags 60. This is illustrated as Level 3 tags (e.g., eligibility tags 13) in FIG. 7. As discussed above, and in more detail for a specific example below, derived data such as an eligibility tag 13 can include data representative of the eligibility of a digital asset 3 for use in a collateral transaction 73, applicable limit, trade desirability, liquidity score, derived rating, etc. Again, as with the above tags 60, 64, 68, derived tags can be represented as a smart contract or series of smart contracts (e.g., a DAML contract(s) as shown in FIG. 16).

### (v) Detailed Example of a Tagging System 401 and Process

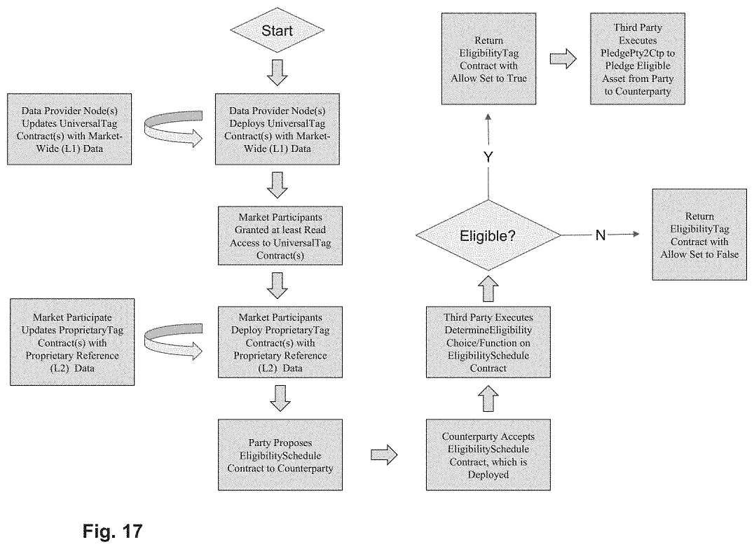

FIG. 11 illustrates a DLT platform offered by the Applicant (and detailed more fully above), which includes a Data Prov (public data sources 461) and Network Participants 463 (similar to proprietary data source 63 described above). The Data Prov 461 and Participants (P1-P3) 463 in FIG. 7 can be associated with a node(s) of the DLT network, and therefore, may be referred to herein as a Data Prov Node(s) 461 and Network Participant Node(s) 463, respectively, for the rest of the present disclosure. A version of Applicant's DLT platform is described in more detail in WO/2018/013934, titled Digital Asset Architecture, which is hereby incorporated by reference herein in its entirety. The following detailed process is illustrated by the flowchart in FIG. 17.

### (vi) Associating (Universal) Public Data Tags 64

In an example, a Data Prov Node(s) 461 can generate and record a DAML contract(s) including market-wide data, similar to as found in FIG. 12 (hereinafter, “UniversalTag Contract”), onto the distributed ledger 455 for purposes of sharing market-wide data, in the form of a contract(s), with other participants. FIG. 12 illustrates an exemplary UniversalTag Contract as a RatingTag for public data tagging. The distributed ledger 455 can, in an example, include distributed ledger 1007 disclosed above (e.g., with a GSL 1013 and PCS 1015), or it can be distributed ledger 1107. The process for recording a smart contract to either ledgers 1007, 1107 is detailed above. The following example is discussed in more detail with reference to distributed ledger 455 being similar to distributed ledger 1007 (e.g., with a GSL 1013 and PCS 1015), but it is to be understood that the example can operate using distributed ledger 1107 instead.

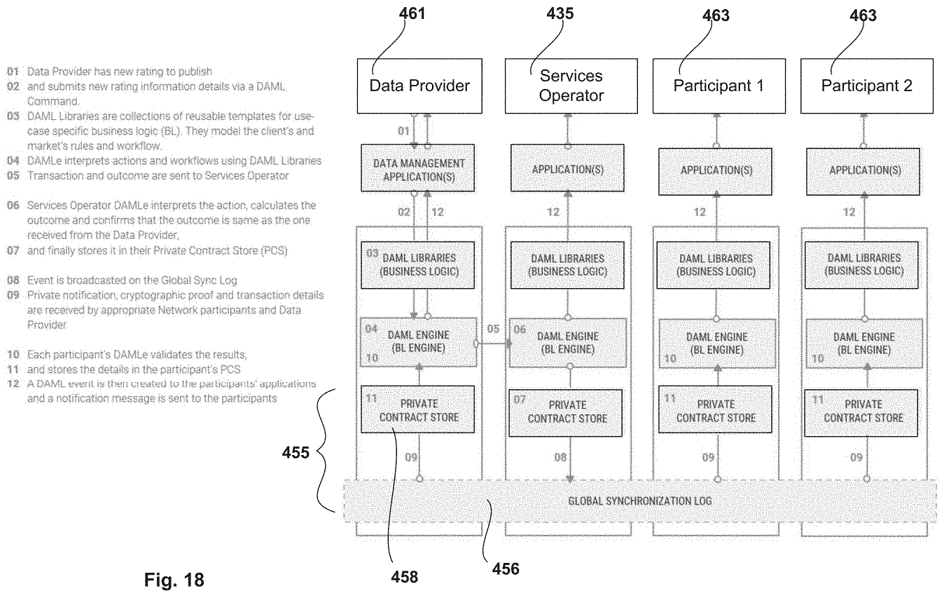

First, when market-wide, public input data 62 is available for publication, a Data Prov Node(s) 461 can send a DAML Command via the Platform API of FIG. 11 to its DAML Execution Engine (“DAMLe”), which is interpreted by DAMLe and translated into a transaction(s)—i.e., Steps 01-04 of FIG. 18. The DAML Command and the transaction(s) can then be sent to a Services Operator/Committer Node(s) 435 (which can operate similar to third node 35 described above), for instance by way of the Committer API of FIG. 11—i.e., Step 05 of FIG. 18. The transaction(s) can be a message to the Committer Node(s) 35/435 to exercise a choice on a contract that has been previously deployed, which defines the rights and obligations of parties in the collateral network. For instance, the message for exercising a choice can be a choice by the Data Prov Node(s) 461 to modify market-wide data set forth in a UniversalTag Contract 64 previously deployed to the network. This is shown in FIG. 12 where controller publisher has a “Modify” choice that, when executed, modifies the UniversalTag Contract (e.g., data stored thereby). The message sent to the Committer Node(s) can contain an event that archives an original instance of the UniversalTag Contract, and creates a new instance of the UniversalTag Contract 64 with new market-wide data 62. The process for archiving DAML contracts and creating new instances is detailed more fully above.

As used herein, a “choice” in a DAML contract can constitute program instructions (e.g., a code segment(s)) that is executable by a “controller” upon providing such controller's cryptographic signature. In an example, execution of the program instructions or code segment(s) requires the controller's cryptographic signature for execution to occur. A cryptographic signature can include a digital signature derived from a public/private key pair associated with a node (e.g., a node associated with the “publisher” above) using a signature algorithm (e.g., the Digital Signature Algorithm (DSA) provided by the NIST), or another cryptographic signature using a different signature algorithm. Thus, merely for example, the “Modify” choice of FIG. 12 can constitute program instructions or a code segment(s) that is executable by a node associated with the “controller publisher” upon providing such node's cryptographic signature. The particular Modify choice of FIG. 12 can permit a node associated with the publisher to change any of the tags 60 in the RatingTag contract upon providing its cryptographic signature, which can cause the existing instance of the RatingTag contract to be archived, and a new RatingTag DAML contract with a different tag(s) 60 to be instantiated and recorded to the distributed ledger 455. Allowing a node to execute program instructions or a code segment(s) once its cryptographic signature is provided can provide security guarantees and assurances to participants relying on a DAML contract containing such code segment(s), since participants can be guaranteed that only certain permitted nodes can execute permitted code in the DAML contract (e.g., to update the tags 60 therein). The remainder of the disclosure uses similar terminology above—e.g., exercising a “choice” in a DAML contract—and it is to be understood that exercising a “choice” can involve the process and/or mechanisms disclosed in this paragraph.

As detailed more fully below (e.g., in ¶[0187]), other DAML contracts can also reference or subscribe to the UniversalTag Contract 64, for instance for purposes of determining the eligibility of a digital asset 3 for a transaction.

After Steps 01-05, as shown in FIGS. 11 and 18, the Services Operator/Committer Node(s) 435 DAMLe can interpret the DAML Command in Step 06 to confirm that the transaction it received in Step 05 is valid. For instance, the Committer Node(s) 435 can validate, by running the DAML Command received by the Data Prov Node(s) 461 in its own DAMLe, among other things, that the message sender had the right to see the existing instantiation of the UniversalTag Contract, the sender had a right to exercise a choice (e.g., data modification choice) on the UniversalTag Contract, any new transaction(s) signatories/owners can be bound/placed into an obligable position, the DAML was correctly interpreted, and the most-recent version of DAML was used. The Committer Node(s) can also ensure the existing instance of the UniversalTag Contract has not already been archived by a prior transaction, and determine who should be notified of the transaction, once it has been recorded to the distributed ledger 455 (e.g., GSL 456 of the distributed ledger 455).

Once validation is complete, the Committer Node(s) 435 can store the new UniversalTag Contract 64 in its PCS 458 (Step 07 of FIG. 18) and add the aforementioned transaction to its transaction buffer (Transaction Mempool of FIG. 11) for eventual commitment to the distributed ledger 455, including the GSL 456. In the context of this specification, reference to PCS 458 can be a reference to a private data store for that node. The transaction can be added to the Transaction Mempool along with other transactions, which ultimately can be combined in a block of the GSL 456. Either the passage of a set amount of time or exceeding a maximum transaction limit in the Mempool can trigger the Committer Node(s) 435 to produce a new block on the GSL 456 and notify relevant participants.

An event can then be broadcast on the GSL 456 (Step 08 of FIG. 18) and a private notification, cryptographic proof and transaction details sent by the Committer Node(s) 435 to appropriate Network Participant Node(s) 463 and Data Prov Node(s) 461 (Step 09 of FIG. 18). Whether or not a participant/node in the network receives the aforementioned private notification (Step 09 of FIG. 18) can depend on whether the participant/node 461, 463 is a stakeholder on the new UniversalTag Contract 64. A stakeholder can include (1) obligable parties (e.g., signatories/owners of the contract), (2) parties having rights (e.g., parties having an exercise choice under the contract), or (3) parties having observer (e.g., read-only) privileges to the contract. If the participant/node is a stakeholder, it can receive the private notification described above. If not, the participant/node can simply receive the GSL block. The private notification can be a message sent, via a private, optionally encrypted secure channel (e.g., through the Replicator and Block Fetcher of FIG. 11), to stakeholders of a contract that provides:
1. The new GSL block
2. An archival event of the original UniversalTag Contract
3. The data of the newly created UniversalTag Contract
4. Merkle proofs of the create and archive events
5. Merkle proofs of the notification of the create and archive events

As shown in FIG. 18, each stakeholder node's DAMLe can then validate the results (validation process described above ¶[0185]), store the new UniversalTag Contract 64 in its PCS 458, and then send a DAML event to any connected applications and/or send a notification message to the stakeholder. The DAML event can be sent to any connected applications through an API so that the stakeholder or any of its applications listening for contract changes can be notified of a change to the UniversalTag Contract.

Using the above mechanism, only actual stakeholders to a UniversalTag Contract 64 can be notified of a modification to the contract (e.g., any of the market-wide reference data therein), and any resulting smart contract can be stored in the PCS 458 of only stakeholders to the UniversalTag Contract.

It should be appreciated that while only a single UniversalTag Contract is discussed above, the present disclosure can utilize multiple UniversalTag Contracts that each refer to the same unique identifier 8, and thus each point to the same digital asset or digital-asset classification. Different UniversalTag Contracts can be provided by, for example, different data providers (e.g., Moody's vs. S&P).

(vii) Associating Proprietary (Participant-Specific) Data Tags 68

Proprietary reference tags 65, 68 can be updated through multiple different mechanisms, including for example: (1) if certain proprietary reference tags 68 are dependent or derived at least partly from market-wide (L1) tags 62 recorded on-ledger 455, in response to an update in market-wide (L1) tags 62; and/or (2) if certain proprietary reference tags 65, 68 are dependent or derived at least partly from non-L1 tags (e.g., computed off-ledger or depend on off-ledger data), in response to updates to such tags.

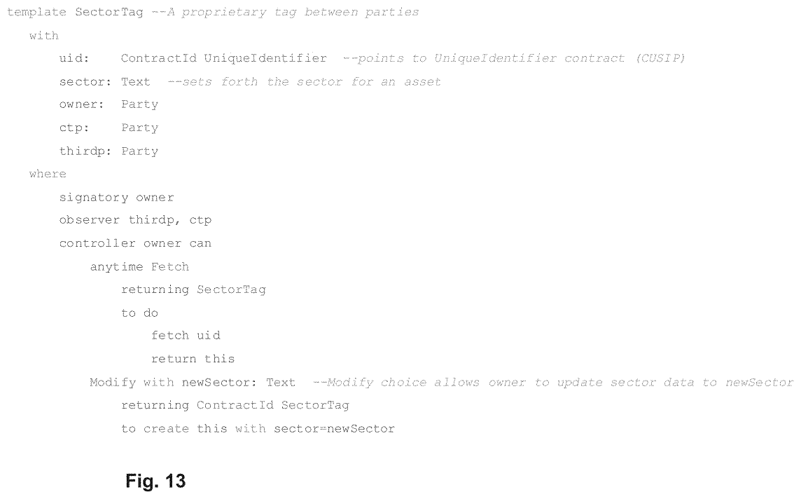

FIG. 13 illustrates a SectorTag contract, which is an example of a proprietary tag contract (hereinafter “ProprietaryTag Contract”) for proprietary data tagging. In FIG. 13, a digital asset 3′s sector (e.g., telecom, mining, government, etc.) is being tracked. The sector tag of FIG. 13 can fall under scenario (2) above since sector data can be a proprietary set of data 65 created by an organization 463. It is to be understood, however, that any ProprietaryTag Contract can include asset tags 60 that are dependent or derived from market-wide data 62 as well (scenario (1) above). Both scenarios (1) and (2) are described below.

In scenario (1), when market-wide data 62 is updated in a UniversalTag Contract 64, archive and create events can be sent to each stakeholder, which can allow the stakeholder (e.g., Network Participant Node(s)) 463 to listen and act on such events and update any associated ProprietaryTag Contract(s) 68. A couple mechanisms can exist to achieve this: (a) proactively updating any ProprietaryTag Contract(s) 68 in response to archive/create events, or (b) “lazily” update any ProprietaryTag Contract(s) 68.

For (a), as noted above, when data in the UniversalTag Contract 68 is updated, a message can be sent by the Committer 435 to each stakeholder 463 that includes:
An archive event for the original UniversalTag Contract meant to remove the contract from the set of active contracts in the stakeholder's PCS 458.
A create event for the new UniversalTag Contract, meant to insert the new contract into the PCS 458.
A new GSL block comprising transaction and notification hashes for the archive and create events (among possibly other events).
Merkle proofs that allow each stakeholder to verify that the archive and create events are valid (i.e., that their PCS is consistent with the GSL).
Merkle proofs that allow each stakeholder to verify that it has received the correct notifications and it did not miss any notifications.

After receiving the message from the Committer Node(s) 435, each stakeholder (e.g., Network Participant Node(s) 463) can verify the data of the newly created UniversalTag Contract 68, including its archival, is correctly hashed and included in the Merkle root of the GSL block it received. This can involve simply hashing the newly-created UniversalTag Contract data 65 received by the Committer 735 and using the hash and/or other hashes provided to the stakeholder to reconstruct the Merkle tree and verify that the new UniversalTag Contract 68 is in the GSL block that all received. Such verification can give assurance to the stakeholder that the new UniversalTag Contract 68 is in the GSL block that was properly communicated to all network participants.

In addition, the stakeholder can configure its own applications to listen to “create” and “archive” events that are received by the Committer 435 (e.g., through a custom API). To proactively update any ProprietaryTag Contract(s), these connected applications can retrieve new market-wide data 62 that would be part of a new UniversalTag Contract 64, which is sent along with the new UniversalTag Contract 64 provided to all stakeholders. In other words, the “create” and/or “archive” events can:
1. Trigger a stakeholder to retrieve a new UniversalTag Contract 64 from its PCS 458 as it is received from the Committer Node(s) 435;
2. Compare market-wide reference data 62 from the new UniversalTag Contract 64 with prior market-wide reference data provided by an earlier version(s) of the UniversalTag Contract;
3. If a change in market-wide reference data 62 for a particular digital asset 3 or digital-asset classification (as identified by its unique identifier 8) is detected, recompute any proprietary reference data 65 that might depend on such changed market-wide data 62; and
4. Exercise a choice (e.g., a modify choice) on any associated ProprietaryTag Contract(s) 68 to update proprietary reference data 65 in such contract(s), archive the outdated ProprietaryTag Contract(s), and create and record a new ProprietaryTag Contract(s) to the GSL 456.

Step 4 above can involve the same process as set forth above for recording updates to the UniversalTag Contract 64 in the GSL 45. Such steps can be conceptualized by looking to Steps 1-12 in FIG. 18, except that the steps outlined would be for proprietary data instead of market-wide data. In addition, different from FIG. 18, any Network Participant Node(s) 463 that is not a stakeholder on the ProprietaryTag Contract (e.g., a signatory or observer) would not be notified of any change to the ProprietaryTag Contract 68 and would not have a copy of the ProprietaryTag Contract 68 in its PCS 458. This serves to maintain confidentiality of proprietary reference data as ProprietaryTag Contracts 68 are only shared/stored in the PCSs of stakeholders with rights to see the proprietary reference data 65.

For (b)—i.e., “lazily” updating a ProprietaryTag Contract 468—the process above can be similar except for a few changes. To lazily update a ProprietaryTag Contract 468, stakeholders can exercise a non-archiving, non-creating choice (e.g., a fetch) that attempts to retrieve/fetch from the ledger any data of any UniversalTag Contract on which a ProprietaryTag Contract depends. If the UniversalTag Contract has been archived, the ledger 455 can reject any fetch requests since the original contract has been deprecated. Such a failed fetch can trigger an update of the ProprietaryTag Contract using the same mechanism above -i.e., Steps 1-4 immediately above.

Processes (a) and (b)—proactively or lazily updating the ProprietaryTag Contract -can also occur due to changes in non-L1 data 62 in much the same manner For instance, a ProprietaryTag Contract can include proprietary reference data 65 that depends on information stored off ledger (e.g., certain proprietary or non-public data). A stakeholder can configure its own applications to listen for changes in any off-ledger data that might impact on-ledger data in any ProprietaryTag Contract and, if such off-ledger data changes, trigger an update to any connected ProprietaryTag Contracts using the process described above. Certain proprietary reference data 65 might be stored or computed off-ledger because computation is expensive or impractical to do on-ledger. Similarly, certain proprietary reference data might be dependent upon off-ledger data since such data might itself be proprietary and/or non-public.

The sector field of FIG. 13 in the SectorTag contract is an example of non-L1 data that can be updated in response to how an organization classifies a particular asset, by sector. Thus, the SectorTag contract can be updated if an organization internally changes the sector classification for a particular asset.

(viii) Associating Derived Eligibility Tag

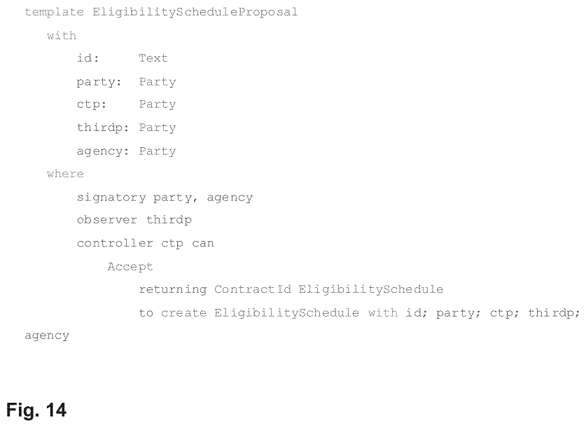

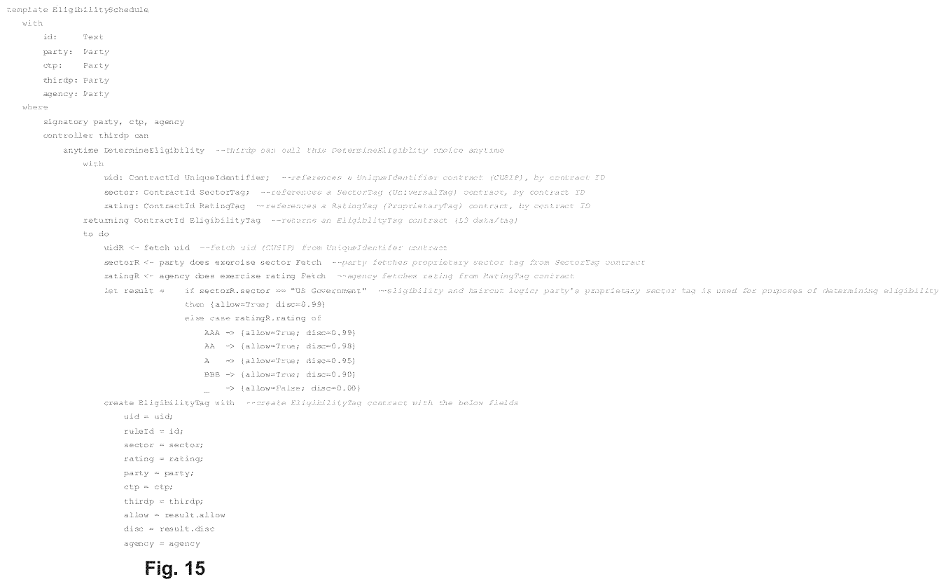

FIGS. 14 and 15 illustrate an example of a propose/accept mechanism for creating an eligibility schedule between counterparties. In a collateral management system, for example, an eligibility schedule can be used to determine whether a particular digital asset 3 is eligible for pledging as collateral 80.

In FIG. 14 an EligiblityScheduleProposal Contract is shown. A party, associated with the first node 5, can propose 101 a DAML eligibility schedule 7 to a counterparty (ctp), associated with a second node 25, using the EligiblityScheduleProposal Contract. As shown, the counterparty (ctp) can have an Accept choice on the DAML contract that, if exercised, returns a valid EligiblitySchedule Contract (FIG. 15) that lists at least the party and the counterparty (ctp) as signatories. As mentioned previously and for all “choices” disclosed herein, the Accept choice of FIG. 14 can constitute a code segment(s) that is executable by the counterparty (ctp) upon providing such counterparty' s (ctp) cryptographic signature. In an example, the counterparty' s (ctp) cryptographic signature is required to execute the code segment(s). Thus, the party associated with the first node 5 can be assured that the counterparty (ctp) associated with the second node 25, and not another party associated with a different node in the network that does not have authorization, can execute the Accept code segment(s) and create a valid EligibilitySchedule Contract (FIG. 15) between the nodes 5, 25 that can be recorded to the ledger 455. As can be appreciated, allowing parties associated with nodes to adopt an EligibilitySchedule Contract in a peer-to-peer fashion results in a number of benefits. The parties do not necessarily have to disclose the EligibilitySchedule Contract to a central agent or intermediary, although the parties can elect to do so to have the central agent or intermediary manage and/or execute the EligibilitySchedule Contract. In addition, it allows parties associated with nodes to amend or change an EligibilitySchedule Contract by submitting another EligibilityScheduleProposal that archives an existing EligibilitySchedule Contract. Parties associated with nodes can therefore change, in a peer-to-peer fashion, the constraints on the eligibility of a digital asset for a transaction (e.g., collateral transaction) between the parties.

By virtue of the fact that the party associated with the first node 5, in the example above, sent the EligibilityScheduleProposal Contract, it can be said that such party implicitly agreed to the counterparty (ctp) creating the EligibilitySchedule Contract on behalf of the nodes 5, 25. In an example, such implicit agreement can be said to be present since the party associated with the first node 5 cryptographically signed the EligibilityScheduleProposal Contract sent to the counterparty (ctp) associated with the second node 25. In a further example, the EligiblityScheduleProposal Contract can also be recorded to the ledger 455 (e.g., the GSL and PCSs of the party and counterparty (ctp)) as part of the above proposal process, which can provide further assurance and confirmation between the parties that the DAML contract is valid as its validity can be checked by referring to the GSL.

FIG. 15 illustrates an EligibilitySchedule Contract that can be returned from the above-described EligiblityScheduleProposal Contract, if the eligibility proposal 7 is accepted. The EligibilitySchedule Contract can define what the parties consider to be eligible collateral 80 based off certain market-wide (L1) 62 and proprietary (L2) data 65. It is to be appreciated that FIG. 15 merely illustrates an exemplary eligibility schedule, and that different eligibility schedules taking into account different parameters and using different DAML logic to determine eligibility of a digital asset 3 for a transaction can be used.

In the example of FIG. 15, the party and counterparty (ctp) have delegated the authority to determine whether a digital asset 3 is eligible collateral 80, as between the party and counterparty (ctp), to a third party (thirdp) (e.g., associated with a third node 35). As shown, the third party (thirdp) can, anytime, call a DetermineEligibility choice on the EligiblitySchedule Contract. The DetermineEligiblity choice can cause execution of the code segment(s) associated with the choice to determine if a digital asset 3 is eligible collateral between the nodes 5, 25. In an example, the third party can be a collateral agent between the party and counterparty (ctp).

It is to be appreciated that the DetermineEligiblity choice can be, alternatively, provided to the first node 5 or the second node 25 instead of the third node 35. In such an example, the parties associated with the first and second nodes 5, 25 would be determining the eligibility of a digital asset 3 for a transaction in a peer-to-peer manner In a further example, execution of the DetermineEligiblity choice can require a cryptographic signature by the first node 5, the second node 25, and/or the third node 35. In the example of FIG. 15, the DetermineEligiblity choice can be executed upon the third node 35 providing its cryptographic signature to execute the relevant code segment(s) and determine eligibility of a digital asset 3 for a particular transaction (e.g., a collateral transaction). In some cases, the third node 35 can be required to provide its cryptographic signature to execute the relevant code segment(s).

The DetermineEligibility choice on the EligiblitySchedule Contract can give the third party (thirdp) an ability to create an EligbilityTag Contract (FIG. 16) based on the state of market-wide (L1) 62 and/or proprietary (L2) 65 data and record such EligiblityTag Contract to the ledger 455. Eligibility can be based on a specified algorithm 11, an example of which is provided below and in the code segment(s) of the DetermineEligiblity choice in FIG. 15. In FIG. 15, if the “sector” field of the SectorTag Contract (FIG. 13) is equal to “US Government”, then an EligibilityTag Contract can always be created with a discount (disc) of 0.99. Otherwise, the party and counterparty (ctp) agree to only accept as collateral digital assets that have a rating higher than BBB, with the applicable discounts/haircuts (disc) shown. If the rating is below BBB, the “allow” field on the EligiblityTag Contract is set to false (e.g., to signify that the digital asset is not eligible collateral).

FIG. 16 illustrates an EligibilityTag Contract, which specifies whether a particular digital asset 3 is eligible as collateral 80 between parties, and gives the third party (thirdp), which can be a collateral agent, the ability to pledge collateral that has been deemed eligible. As shown, the “allow” field on the EligiblityTag Contract, which is generated in the EligiblitySchedule Contract detailed above, can provide a Boolean value (true/false) to signify whether a particular asset is eligible as collateral between the party and counterparty (ctp). The EligibilityTag Contract can also point to a particular unique identifier 8 (e.g., “uid” field) so that it is clear which digital asset 3 or digital-asset classification is eligible as collateral between the party and counterparty (ctp).

As shown in FIG. 16, the third party (thirdp) can have a PledgePty2Ctp choice on the EligibilityTag Contract that allows the third party to pledge eligible collateral 80 from the party to the counterparty (ctp). This is similar to step 321 and 323 performed by the third node 35 as described above. First, the PledgePty2Ctp function can check that the “allow” field on the EligibilityTag Contract is set to “true”, indicating the digital asset 3 is eligible for the transaction, and then the PledgePty2Ctp code segment(s) can fetch an “Asset” DAML contract (not shown in the figures). The Asset DAML contract can constitute the digital asset 3 that is recorded to the ledger 455, and may provide certain fields indicating ownership of the digital asset 3, quantity of the digital asset 3, etc. The PledgePty2Ctp function can then execute an “Encumber” choice on the DAML Asset contract (not shown), which acts to pledge or encumber the asset from the party to the counterparty (ctp).

In an example, the Encumber choice on the DAML Asset contract can be a choice to lock the digital asset 3 so that the digital asset 3 can be provably utilized as collateral between the party to the counterparty (ctp) for some predefined period of time, and cannot be used in any other transaction. A process for committing to settle or participate in a transaction is disclosed in U.S. Ser. No. 16/051,128, filed on Jul. 31, 2018 by the Applicant and titled “Method and Apparatus for Automated Committed Settlement of Digital Assets”, the disclosure of which is hereby incorporated by reference herein in its entirety (hereinafter, the “Committed Settlement Application”). It is to be appreciated that the Encumber choice mentioned above can be a choice that activates a lock on a lockable digital asset 3 for purposes of committing the digital asset 3 to serve as collateral between the party and the counterparty (ctp). Likewise, it is also to be appreciated that the Encumber choice can be a choice that provides a deactivation mechanism (e.g., an Unlock choice as shown in FIG. 22 of the Committed Settlement Application) to deactivate the aforementioned lock after the parties have satisfied their obligations and the digital asset 3 is no longer applicable collateral between the parties. In other words, the Encumber choice can be a code segment(s) that is executable upon providing the cryptographic signature of the first 5, second 25, and/or third 35 nodes that, when executed, activates a lock as described in the Committed Settlement Application and locks the digital asset 3 as collateral between the party and counterparty (ctp). If, for instance, the party defaults on its obligations to the counterparty (ctp), the activated lock could provide yet another code segment(s) executable by the counterparty (ctp) upon providing its cryptographic signature (and subject to certain conditions/logic, such as a default) that, when executed, acts to transfer the digital asset 3 from the party to the counterparty (ctp). In this way, the counterparty (ctp) can be assured that the digital asset 3 is locked for purposes of serving as collateral and, if the party defaults on its obligations, the counterparty (ctp) has a cryptographically-executable code segment(s) that can provably transfer ownership of the digital asset 3 from the party to the counterparty (ctp). Likewise, the party can be assured that it has a cryptographically-executable code segment(s) that can provably deactivate the lock on the digital asset 3 if the party satisfies it obligations to the counterparty (ctp). As such, the concepts described in the Committed Settlement Application can be utilized along with the present examples to ensure a peer-to-peer collateral transaction can be affected between the party and counterparty (ctp) without counterparty risk and/or any central intermediary.

As an alternative to the preceding, the present system can be used with existing collateral-management systems in that the DAML Asset contract can simply be a record of an asset's eligibility and ownership as of a certain time. Then, an existing collateral-management system can read from the ledger 455 and act to actually pledge collateral from the party to the counterparty if the DAML Asset contract permits.

In the examples above, it is to be appreciated that the PledgePty2Ctp choice, similar to the DetermineEligiblity choice can be, alternatively, provided to the first node 5 or the second node 25 instead of the third node 35. In a further example, execution of the PledgePty2Ctp choice can require a cryptographic signature by the first node 5, the second node 25, and/or the third node 35. In the example of FIG. 16, the PledgePty2Ctp choice can be executed upon the third node 35 providing its cryptographic signature to execute the relevant code segment(s) and pledge the digital asset 3 determined to be eligible collateral in the DetermineEligiblity choice from the party to the counterparty (ctp).

### (ix) Optimization and Allocation

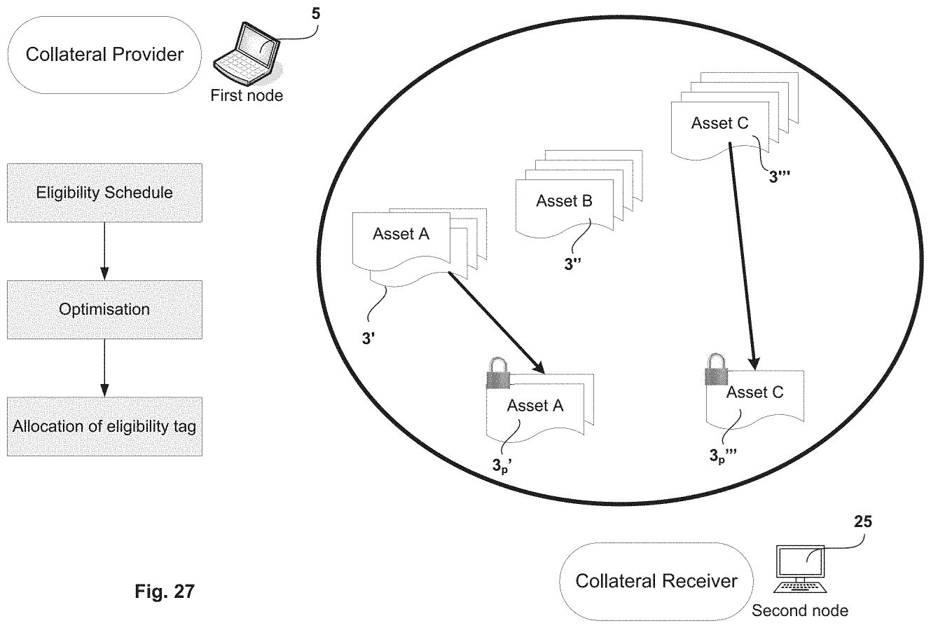

FIG. 27 illustrates a schematic of a particular transaction between a collateral provider (e.g., the party detailed above) and a collateral receiver (e.g., the counterparty (ctp) detailed above). In an embodiment, the collateral provider can be associated with the first node 5, and the collateral receiver can be associated with the second node 25. This exemplary transaction demonstrates a peer-to-peer collateral transaction between nodes 5, 25.

As shown in FIG. 27, the collateral provider node 5 can utilize an EligibilitySchedule Contract between the provider node 5 and the receiver node 25 to make a determination about whether any number of digital assets 3′ , 3″, 3′′ are eligible for a collateral transaction between the provider 5 and receiver 25 nodes. In an example, this can take the form of the provider node 5 or the receiver node 25 executing the DetermineEligibility choice of an EligibilitySchedule Contract between the nodes 5, 25. As mentioned previously, the DetermineEligiblity choice can be a code segment(s) that is executable by either or both nodes 5, 25 upon providing a cryptographic signature of either or both nodes 5, 25 that, when executed, makes a determination about whether a particular digital asset 3′, 3″, 3″′ is eligible as collateral between the nodes 5, 25, and returns an EligibilityTag Contract if the digital asset 3′, 3″, 3″′ is eligible. Exemplary logic for determining eligibility can be found in the DAML of the DetermineEligibility choice.

The provider node 5 and/or the receiver node 25 can also configure their nodes so that, if an L1 tag 64 (e.g., the RatingTag Contract) and/or an L2 tag 68 (e.g., the SectorTag Contract) changes, the DetermineEligiblity choice can be executed by the provider node 5 or the receiver node 25 to determine whether the particular digital asset 3 is eligible or not eligible as collateral between the provider 5 and receiver 25 nodes according to the EligiblitySchedule Contract. In contrast to existing centralized system, this can permit the provider 5 and receiver 25 nodes to compute, in real time and peer-to-peer, the eligibility of a digital asset 3′, 3″, 3″′ for a collateral transaction. Existing centralized systems are, contrary to the examples of the disclosure, reactive instead of proactive in their eligibility determinations and require centralization of datasets and computation to make such determinations.

As shown in FIG. 27, Asset A 3′ and Asset C 3″′ have been determined to be eligible collateral, but Asset B 3″ has failed the DetermineEligiblity code segment(s) of the EligiblitySchedule Contract and is ineligible as collateral. Thus, EligibilityTag Contracts are returned from the DetermineEligiblity choice for Asset A 3′ and Asset C 3′″ that place the allow field to true to indicate Asset A 3′ and Asset C 3′″ are eligible collateral. By contrast, an EligibilityTag Contract is returned from the DetermineEligibility choice for Asset B 3″ that places the allow field to false to indicate that Asset B 3″ is ineligible. Asset A 3′ and Asset C 3′″ therefore self-identify as eligible collateral, while Asset B 3″ self-identifies as ineligible via the associated EligibilityTag Contracts.

In the example of FIG. 27, the provider node 5 or an associated off-ledger computer system can then perform optimization calculations on all of the eligible digital assets 3′, 3″, 3′″, such as Asset A 3′ and Asset C 3″′, of the collateral provider to determine which digital assets 3′, 3″, 3″′ would be advantageous to pledge as collateral to the receiver node 25. After any optimizations are performed, the provider node 5 can execute the PledgePty2Ctp choice on the EligibilityTag Contracts for Assets A 3′ and Asset C 3′″ to pledge Assets A and C as collateral to the receiver node 25. In the process, as mentioned above, the provider node 5 can activate a lock (e.g., by way of the Encumber code segment(s)) that commits Asset A 3ₚ′ and Asset C 3ₚ″′ as collateral to the receiver node 25. Such a lock activation process is described in more detail in the Committed Settlement Application. Then, with Asset A 3ₚ′ and Asset C 3ₚ″′ locked for purposes of collateral, both the provider node 5 and the receiver node 25 can have confidence that Asset A 3′ and Asset C 3″′ can be transferred to the receiver node 25 (e.g., in case of a default of the obligations of the provider node 5), or that the lock can be deactivated (e.g., if the provider node 5 satisfies its obligations).

The transactions in FIG. 27 illustrate a peer-to-peer mechanism for asset tagging, determining the eligibility of any number of digital assets 3 for a collateral transaction, and then optimizing and allocating desired digital asset 3 in a collateral transaction. FIG. 27 is exemplary of the benefits of embodiments of the disclosure as compared to traditional, centralized and inefficient systems.

### (x) Variation of System

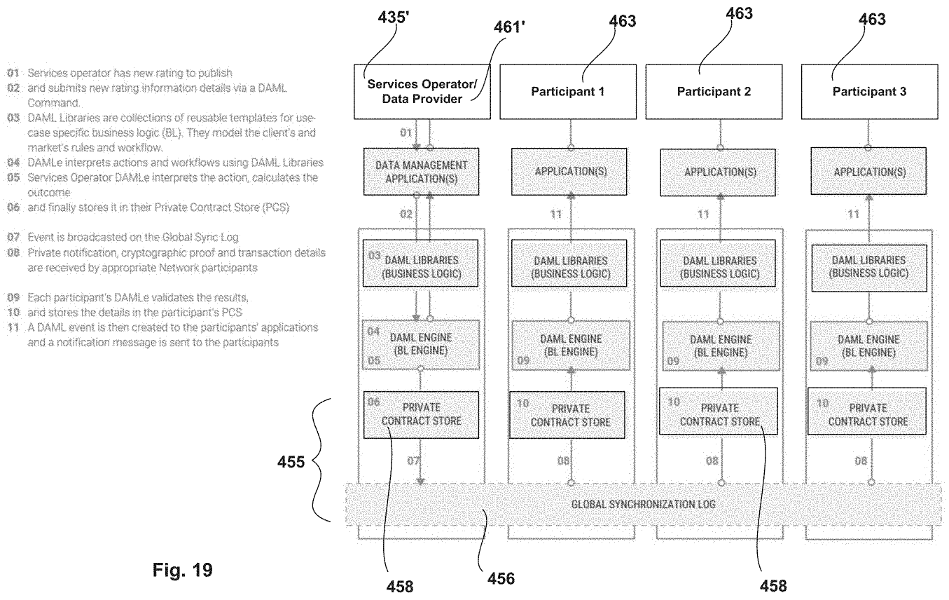

FIG. 19 illustrates a variation of the above mentioned system in FIG. 18, whereby the Service Operator/Committer Node(s) 435 is the same node as one of the Data Prov Node 461′.

FIG. 20 illustrates another variation of the above mentioned system in FIG. 18 whereby one of the Network Participant Nodes 463′ is the same as one of the Data Prov Node 461′.

### 8. Example of a Processing Device

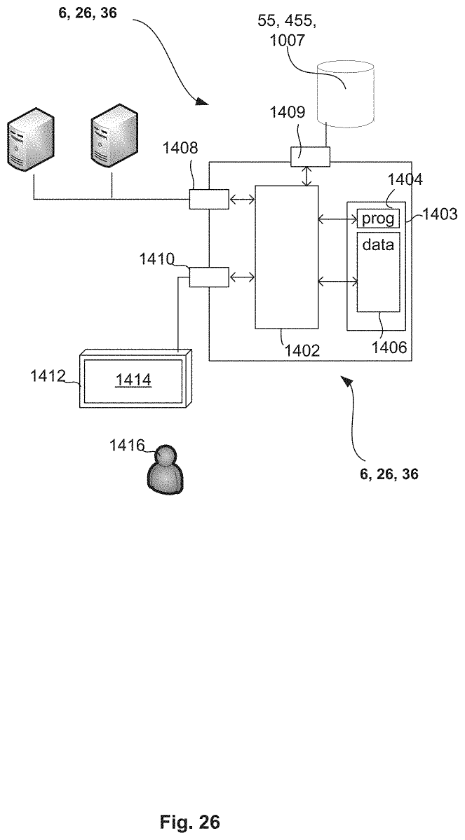

FIG. 26 illustrates an example computer node. The node may be any node in any of the systems disclosed herein, including any of nodes 5, 25, 35. As shown in FIG. 26, the node can include a processing device 6, 26, 36 including a processor 1402, a memory 1403, a network interface device 1408, a distributed ledger interface device 1409 that interfaces with the distributed ledger 55, 455, 1007 and a user interface 1410. The memory can store instructions 1404 and data 1406, and the processor can perform the instructions from the memory to implement the processes as described herein.

The embodiments can include computer-executable instructions, such as routines executed by a general or special-purpose data processing device (e.g., a server or client computer). The instructions can be stored in a non-transient manner or distributed on tangible computer-readable media, including magnetically or optically readable computer discs, hard-wired or pre-programmed chips (e.g., EEPROM semiconductor chips), nanotechnology memory, biological memory, or other data storage media.

The data may be provided on any analog or digital network (e.g., packet-switched, circuit switched, or the like). The embodiments can be practiced in distributed computing environment where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. The embodiments can be implemented as software as a service (SaaS) in a cloud computing environment. Those skilled in the relevant art will recognize that portions of the described technology may reside on a server computer, while corresponding portions reside on a client computer (e.g., PC, mobile computer, tablet, or smart phone).

The information described herein can be transmitted and stored as data structures. Various messaging protocols can be used and each transaction can include a transaction message that includes the sender's digital signature, a recipient address (e.g., a hash value based on the receivers public key). Transaction messages can be digitally signed by the sender's private key to create a digital signature for verifying the sender. The messages can be decrypted using the digital signature via the sender's public key to verify authenticity in a known manner

The computing devices can include a personal computer, workstation, phone, or tablet, having one or more processors coupled to one or more memories storing computer-readable instructions. The various devices can be communicatively coupled in a known manner as via a network. For example, network hubs, switches, routers, or other hardware network components within the network connection can be used.

In general, the description of embodiments of the software and/or hardware facilities is not intended to be exhaustive or to limit the technology to the precise form disclosed above. While specific embodiments of, and examples for, the technology are described above for illustrative purposes, various equivalent modifications are possible within the scope of the software and/or hardware facilities, as those skilled in the relevant art will recognize. The teachings of the software and/or hardware facilities provided herein can be applied to other systems, not necessarily the system described herein. The elements and acts of the various embodiments described herein can be combined to provide further embodiments.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

What is claimed is:

1. A system for determining the eligibility of a digital asset associated with a unique identifier for a transaction, wherein the system comprises:
a first computer node including a first processing device and memory, the computer node including program instructions that, when executed:
send a proposed automated tagging request associated with the digital asset, wherein the proposed automated tagging request comprises an algorithm configured to determine one or more eligibility tags based on input data from one or more input data sources;
receive, from a second node, an acceptance notification indicating acceptance of the proposed automated tagging request; and
validate that program instructions including the algorithm are recorded to a distributed ledger associated with the digital asset.

2. A system according to claim 1 wherein the first node is configured to:
cryptographically sign the proposed automated tagging request with a first digital signature associated with the first node.

3. A system according to either claim 1 wherein the first node is further configured to:
cryptographically validate that the acceptance notification from the second node includes a second digital signature associated with the second node,
wherein validity of the program instructions is conditional on a valid second digital signature.

4. A system according to claim 1, wherein:
the distributed ledger includes a record of one or more of:
the proposed automated tagging request;
the acceptance notification;
the program instructions; and
the one or more eligibility tags associated with the unique identifier.

5. A system according to claim 1 further comprising:
a third node comprising a third processing device and memory configured to:
receive input data recorded on the distributed ledger from at least a first input data source;
execute program instructions, including the algorithm that, based on the input data, associate one or more eligibility tags with the unique identifier of the digital asset, the one or more eligibility tags indicating the eligibility of the digital asset for the transaction;
record a representation of the one or more eligibility tags associated with the unique identifier of the digital asset to the distributed ledger; and
communicate, using a private secure channel to at least one of a first node or a second node, an eligibility tag notification providing data representative of the one or more eligibility tags.

6. A system according to claim 5, wherein the third node is configured to:
validate one or more digital signatures associated with the program instructions,
wherein validity of the program instructions is conditional on the validity of the one or more digital signature.

7. A system according to claim 5, further comprising additional input data sources including:
a public data source to provide public input data; and
a proprietary data source to provide proprietary input data,
wherein the third node is further configured to:
validate accuracy of at least one of the public input data or the proprietary input data with further data of a further input data source.

8. A system according to claim 5 wherein the third node is configured to:
receive, from the first node, a request for a transaction involving the digital asset;
determine the unique identifier associated with the digital asset;
determine, if any, one or more eligibility tags associated with the unique identifier; and
determine authorisation for the transaction based on the one or more eligibility tags;
wherein based on successful authorisation, the third node is configured to:
record the transaction in the distributed ledger.

9. A system according to claim 8, wherein the request further comprises a cryptographic authorisation to transfer control of the digital asset from the first node to the second node based on occurrence of a specified transaction condition,
wherein the third node is further configured to:
monitor input data from the first input data source,
wherein based on identification of an occurrence of the specified transaction condition, control of the digital asset is transferred to the second node.

10. A system according to claim 1 wherein the unique identifier is also associated with a control tag indicating a node having control of the digital asset.

11. A computer-implemented method for determining the eligibility, for a transaction, of a digital asset associated with a unique identifier, the method comprising:
by way of a first node including a first processing device and memory:
cryptographically signing, with a first digital signature associated with the first node, a proposed automated tagging request related to the digital asset, wherein the proposed automated tagging request comprises an algorithm configured to determine at least one eligibility tag based on input data from at least a first input data source;
sending the proposed automated tagging request to a second node;
validating that program instructions including the algorithm are recorded to a distributed ledger associated with the digital asset;
validating that the program instructions including the algorithm have, based on the input data, executed and associated one or more eligibility tags to the unique identifier associated with the digital asset; and
by way of the first node or a third node having a third processing device and memory:
cryptographically signing a transaction involving the digital asset that is recorded to the distributed ledger only if the one or more eligibility tags satisfy predefined criteria.

12. A computer-implemented method according to claim 11 further comprising:
delegating cryptographical signing of the transaction to the third node.

13. A computer-implemented method according to claim 11 further comprising:
by way of the first node:
receiving, from the second node, an acceptance notification indicating an acceptance of the proposed automated tagging request; and
cryptographically validating that the acceptance notification from the second node includes a second digital signature associated with the second node, wherein validating that the program instructions are recorded is conditional on a valid second digital signature.

14. A computer-implemented method according to claim 11, wherein the proposed automated tagging request further comprises one or more of:
a third node identifier associated with the third node;
a third digital signature associated with the third node; and
a third node class identifier associated with a class of nodes of the third node.

15. A computer-implemented method according to claim 11, wherein the first node is associated with a first private data store and the method comprises:
storing one or more of the proposed automated tagging request and the program instructions including the algorithm in the first private data store.

16. A computer-implemented method according to claim 11 further comprising:
by way of the first node:
sending a first encrypted private message, comprising the program instructions including the algorithm, to the third node.

17. A computer-implemented method for determining the eligibility of a digital asset associated with a unique identifier for a transaction, the method comprising:
by way of a third node including a third processing device and memory:
receiving input data recorded on a distributed ledger from at least a first input data source;
executing program instructions including an algorithm that, based on the input data, associates one or more eligibility tags with the unique identifier of the digital asset, the one or more eligibility tags indicating the eligibility of the digital asset for the transaction;
recording a representation of the one or more eligibility tags associated with the unique identifier of the digital asset to the distributed ledger; and
communicating, using a private secure channel to at least one of a first node or a second node, an eligibility tag notification providing data representative of the one or more eligibility tags.

18. A computer-implemented method according to claim 17 wherein communicating the eligibility tag notification comprises:
sending a second encrypted private message including the eligibility tag notification to at least one of the first node or the second node.

19. A computer-implemented method according to claim 17 comprising:
recording a cryptographic representation of the one or more eligibility tags to the distributed ledger, wherein the cryptographic representation comprises a hash of the one or more eligibility tags recorded on the distributed ledger, or the one or more eligibility tags recorded on the distributed ledger in encrypted form.

20. A computer-implemented method according to claim 17, further comprising:
validating a first digital signature of the first node and a second digital signature of the second node associated with the program instructions,
wherein validity of the program instructions is conditional on the validity of the first and second digital signatures.

21. A computer-implemented method according to claim 17, further comprising additional input data sources including:
a public data source to provide public input data; and
a proprietary data source to provide proprietary input data,
wherein the method further comprises:
validating accuracy of at least one of the public input data or the proprietary input data with further data of a further input data source.

22. A computer-implemented method according to 21, wherein validating the accuracy of at least one of the public input data or the proprietary input data includes a comparison of respective cryptographic hashes of the data.

23. A computer-implemented method according to claims 17 further comprising:
receiving, from the first node, a request for a transaction involving the digital asset;
determining the unique identifier associated with the digital asset;
determining, if any, one or more eligibility tags associated with the unique identifier; and
determining authorisation for the transaction based on the one or more eligibility tags;
wherein based on successful authorisation, the method further comprises:
recording the transaction in the distributed ledger.

24. A computer-implemented method according to claim 23, wherein the request further comprises a cryptographic authorisation to transfer control of the digital asset from the first node to the second node based on occurrence of a specified transaction condition,
wherein the method further comprises:
monitoring input data from the first input data source,
wherein based on identification of an occurrence of the specified transaction condition, control of the digital asset is transferred to the second node.
